(19) United States
(12) Patent Application Publication
(10) Pub. No.: US 2026/0270996 A1
(43) Pub. Date: Sep. 10, 2026

(54) ELECTRONIC DEVICE, COMMUNICATION METHOD AND STORAGE MEDIUM

(71) Applicant: Sony Group Corporation, Tokyo (JP)

(72) Inventors: Mingtuo ZHOU, Shanghai (CN); Xiaoxue WANG, Beijing (CN); Haojin LI, Beijing (CN)

(73) Assignee: Sony Group Corporation, Tokyo (JP)

(21) Appl. No.: 18/869,310

(22) PCT Filed: Jun. 1, 2023
(86) PCT No.: PCT/CN2023/097845

§ 371 Date: Nov. 26, 2024

(30) Foreign Application Priority Data
Jun. 6, 2022 (CN) 202210632483.1

(51) Int. Cl. H04W 72/21; H04W 24/08; H04W 72/232

(52) U.S. Cl. CPC H04W 72/21; H04W 24/08; H04W 72/232

(57) ABSTRACT

The present disclosure relates to an electronic device, a communication method and a storage medium. There is provided an electronic device for a base station in a non-terrestrial network, comprising processing circuitry configured to determine to enable uplink coordinated multiple points transmission for a user equipment (UE) in a serving cell provided by the base station; at least based on geographic location of the UE, coverage range and movement information of the serving cell, and coverage range and movement information of neighbor cells, select at least one cooperating cell from the neighbor cells, and determine a cooperation period for the uplink coordinated multiple points transmission; and receive uplink transmission of the UE by cooperation of the serving cell and the at least one cooperating cell within the cooperation period.

### CROSS REFERENCE TO RELATED APPLICATIONS

This application claims the benefit of Chinese invention patent application No.202210632483.1, entitled “ELECTRONIC DEVICE, COMMUNICATION METHOD AND STORAGE MEDIUM”, filed on Jun. 6, 2022, the disclosure of which is incorporated herein by reference in its entirety.

### FIELD OF THE INVENTION

The present disclosure generally relates to a wireless communication system, and more particularly, to an electronic device, a communication method, and a storage medium for use with uplink coordinated multiple points (CoMP) transmission in a non-terrestrial network (NTN).

### BACKGROUND

In recent years, non-terrestrial communication technologies based on, e.g., satellites, have received increasing attentions. The non-terrestrial communication can use mobile platforms such as satellites, drones or the like to serve terminals on the ground or in the air. Compared with terrestrial communications, the non-terrestrial communication has its own advantages and characteristics, such as supporting the provision of communication services to regions lacking infrastructure (such as mountains, deserts, islands, oceans or the like.) or in the case of terrestrial network disruptions (such as when the cellular network is down due to earthquakes, tsunamis, or wars). In addition, the non-terrestrial communication can also make up for disadvantages of a terrestrial communication network in large-scale intensive deployment and high energy consumption.

The 5G New Radio (NR) technology of the 3rd Generation Partnership Project (3GPP) also incorporates into its specification the non-terrestrial network (NTN), which includes satellite parts as a component of its connection infrastructure, and defines enhancements that are opened to support the NTN. The 5G NTN can extend existing terrestrial networks or “fill in” their gaps via satellite links, for example, an Internet of Things (IoT) application located at the edge of coverage or hard-to-reach locations can access the 5G via a satellite broadband link.

In the non-terrestrial network, the terminal may be, for example, a ground terminal for a video surveillance environment installed in a remote region, or a camera terminal installed on a non-communication satellite in the space for space observation. The terminal may have a large amount of uplink data that needs to be transmitted to the communication system. Upload rate requirements of these terminals may be several megabits to tens of megabits, and in order to meet these requirements, possible solutions include allocating more bandwidths to the terminal, using spatial multiplexing technology such as multiple input multiple output (MIMO), or increasing a transmit power to reduce bit error rate. But these solutions either use more resources or consume more energy.

Therefore, there is a need to improve the existing non-terrestrial communication technology so as to provide uplink transmission capacity for the terminal.

### SUMMARY OF THE INVENTION

In light of the above and other issues, the present disclosure provides aspects of uplink coordinated multiple points transmission applicable to the non-terrestrial network.

A brief summary regarding the present disclosure is given here to provide a basic understanding on some aspects of the present disclosure. However, it will be appreciated that the summary is not an exhaustive description of the present disclosure. It is not intended to identify key portions or important portions of the present disclosure, nor to limit the scope of the present disclosure. It aims at merely describing some concepts about the present disclosure in a simplified form and serves as a preorder of a more detailed description to be given later.

According to an aspect of the present disclosure, there is provided an electronic device for a base station in a non-terrestrial network, comprising: processing circuitry configured to determine to enable uplink coordinated multiple points transmission for a user equipment (UE) in a serving cell provided by the base station; at least based on geographic location of the UE, coverage range and movement information of the serving cell, and coverage range and movement information of neighbor cells, select at least one cooperating cell from the neighbor cells, and determine a cooperation period for the uplink coordinated multiple points transmission; and receive uplink transmission of the UE by cooperation of the serving cell and the at least one cooperating cell within the cooperation period.

According to another aspect of the present disclosure, there is provided an electronic device for a base station in a non-terrestrial network (NTN), comprising: processing circuitry configured to receive, from another base station, selection information of a cooperating cell and information on a cooperation period for uplink coordinated multiple points transmission for a user equipment (UE); and in response to the selection information, receive uplink transmission of the UE within the cooperating period by cooperation of the cooperating cell and a serving cell of the UE.

According to another aspect of the present disclosure, there is provided an electronic device for a user equipment (UE), comprising: processing circuitry configured to receive, from a serving cell, information on a scanning beam range for the UE; transmit an uplink signal with each of transmission beams in the scanning beam range; receive, from the serving cell, indication information for an optimal transmission beam of the UE for uplink coordinated multiple points transmission, wherein the optimal transmission beam is determined based on signal quality of the uplink signal transmitted by the UE measured by the serving cell and at least one cooperating cell; and perform uplink transmission with the optimal transmission beam.

According to another aspect of the present disclosure, there is provided a communication method, comprising: determining to enable uplink coordinated multiple points transmission for a user equipment (UE) in a serving cell provided by a base station; at least based on geographic location of the UE, coverage range and movement information of the serving cell, and coverage range and movement information of neighbor cells, selecting at least one cooperating cell from the neighbor cells, and determining a cooperation period for the uplink coordinated multiple points transmission; and receiving uplink transmission of the UE by cooperation of the serving cell and the at least one cooperating cell within the cooperation period.

According to another aspect of the present disclosure, there is provided a communication method, comprising: receiving, from another base station, selection information of a cooperating cell and information on a cooperation period for uplink coordinated multiple points transmission for a user equipment (UE); and in response to the selection information, receiving uplink transmission of the UE within the cooperating period by cooperation of the cooperating cell and a serving cell of the UE.

According to another aspect of the present disclosure, there is provided a computer readable storage medium storing executable instructions which, when executed, perform any of the above communication methods.

### DESCRIPTION OF THE DRAWINGS

A better understanding of the present disclosure may be achieved by referring to a detailed description given hereinafter in connection with accompanying figures, wherein the same or similar reference signs are used to indicate the same or similar elements throughout the figures. The figures are included in the specification and form a part of the specification along with the following detailed descriptions, for further illustrating embodiments of the present disclosure and for explaining the theory and advantages of the present disclosure. Wherein,

FIG. 1 is a simplified diagram illustrating architecture of a NR communication system;

FIG. 2 illustrates two exemplary scenarios for the NTN;

FIG. 3 illustrates a schematic diagram of change of a footprint of a satellite beam with movement of the satellite in the NTN;

FIGS. 4A-4D illustrate examples of applying uplink CoMP in the NTN according to the present disclosure;

FIG. 5 illustrates a flowchart of the uplink CoMP in the NTN;

FIG. 6 illustrates a schematic diagram of uplink transmission of a UE in an uplink CoMP period.

FIG. 7 illustrates a flowchart of the uplink CoMP in the NTN;

FIG. 8A illustrates an example of the uplink CoMP based on a joint reception algorithm;

FIG. 8B illustrates an example of the uplink CoMP based on a hard-decision dynamic cell selection algorithm;

FIGS. 9A-9D are schematic diagrams for selection of cooperating cell(s) in the uplink CoMP scenarios;

FIG. 10 illustrates a flow diagram for determining a beam for uplink transmission in a case where the uplink CoMP is not applied;

FIG. 11 illustrates schematic diagrams of projecting a cooperating cell and a serving cell by different satellite base stations.

FIG. 12 illustrates a flowchart for determining a beam for uplink transmission in a case where the uplink CoMP is applied in the NTN;

FIG. 13 illustrates an example of a scanning beam range according to an embodiment of the present disclosure;

FIG. 14 illustrates a schematic diagram of time advance in uplink transmission;

FIG. 15 illustrates a flowchart of adjusting a reception time of a cooperating cell according to an embodiment of the present disclosure;

FIGS. 16A and 16B illustrate an electronic device on the control device side and a communication method thereof according to the present disclosure;

FIGS. 17A and 17B illustrate an electronic device on the control device side and a communication method thereof according to the present disclosure;

FIGS. 18A and 18B illustrate an electronic device on the user equipment side and a communication method thereof according to the present disclosure;

FIG. 19 illustrates a first example of schematic configuration of the base station according to the present disclosure;

FIG. 20 illustrates a second example of schematic configuration of the base station according to the present disclosure;

FIG. 21 illustrates an example of schematic configuration of a smart phone according to the present disclosure; and

FIG. 22 illustrates an example of schematic configuration of an automobile navigation device according to the present disclosure.

Further features and aspects of the present disclosure will become apparent from the following description with reference to the attached drawings.

### DETAILED DESCRIPTION OF PREFERRED EMBODIMENTS

Various illustrative embodiments of the present disclosure will be described hereinafter with reference to the drawings. For purpose of clarity and simplicity, not all features of the embodiments are described in the specification. It is to be noted that, however, many implementation-specific settings may be made in practicing the embodiments of the present disclosure according to specific requirements, so as to achieve specific goals of the developers, such as for compliance with constraints related to a device and a service, which may vary from implementations.

In addition, it is to be noted that to avoid obscuring the present disclosure with unnecessary details, the figures illustrate only steps of a process and/or components of a device that are closely related to technical solutions according to the present disclosure, while other details that have little relation to the present disclosure are omitted.

For convenient explanation of the technical solutions of the present disclosure, various aspects of the present disclosure will be described below in context of the 5G NR. However, it is to be noted that this is not a limitation on the scope of application of the present disclosure. One or more aspects of the present disclosure can also be applied to wireless communication systems that have been commonly used, such as the 4G LTE/LTE-A, or various wireless communication systems to be developed in future. The architecture, entities, functions, processes and the like as described in the following description are not limited to those in the NR communication system, and can be found in other communication standards.

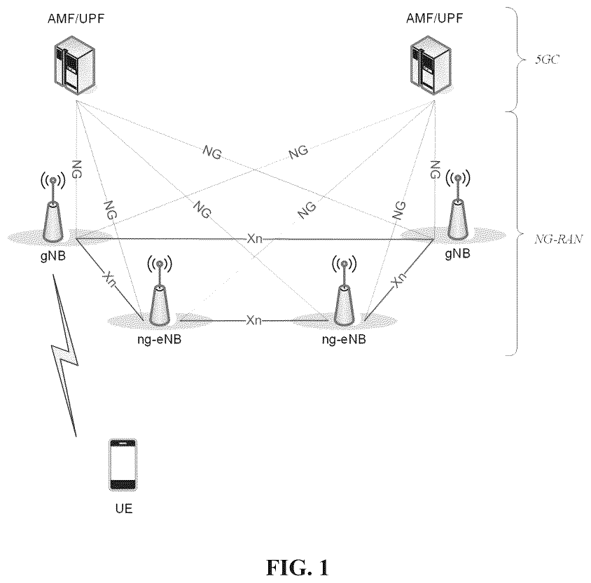

FIG. 1 is a simplified diagram illustrating an architecture of a 5G NR communication system. As shown in FIG. 1, on the network side, radio access network (NG-RAN) nodes of the NR communication system include gNBs and ng-eNBs, wherein the gNB is a newly defined node in the 5G NR communication standard, which is connected to a 5G core network (5GC) via a NG interface and provides NR user plane and control plane protocols terminating with a terminal equipment (also referred to as “user equipment”, simply referred to hereinafter as “UE”); the ng-eNB is a node defined to be compatible with the 4G LTE communication system, which can be upgradation of an evolved Node B (eNB) of the LTE radio access network, is connected to the 5G core network via the NG interface, and provides evolved universal terrestrial radio access (E-UTRA) user plane and control plane protocols terminating with the UE. The gNB and ng-eNB are collectively referred to hereinafter as a “base station”.

However, it is to be noted that the term “base station” used in the present disclosure is an example of a control device in a wireless communication system, and has the full breadth of its general meaning. Depending on a scenario where the technical solution of the present disclosure is applied, the base station may be located on an aerial mobile platform, such as a satellite, a space station, an aircraft, an airship, a hot air balloon, a drone, or the like; also may be located on the ground, such as a ground transceiver station, a drone control tower, or the like. Moreover, in addition to the gNB and ng-eNB specified in the 5G communication standard, the base station may also include an eNB in the LTE communication system, a remote radio head, a wireless access point, or a communication device that performs similar functions. Application examples of the base station will be described in detail in the following chapter.

In addition, the term “UE” used in the present disclosure has the full breadth of its general meaning, and includes various terminal devices or vehicle-mounted devices that communicate with a base station. For example, depending on a scenario where the technical solution of the present disclosure is applied, the UE may be a terminal device such as a mobile phone, a laptop, a tablet, a vehicle-mounted communication device, a video camera, a device on a satellite or the like, or elements thereof. Application examples of the UE will be described in detailed in the following chapter.

The 5G NR may be deployed as a non-terrestrial network (NTN), that is, compared with a traditional terrestrial network, the NTN is deployed using a typical satellite or High Altitude Platform. Taking satellite communication as an example, it is advantageous evidently that only 3 geostationary orbit satellites (GEOs) are needed to cover the globe except for bipolar areas. There are also numerous satellite communication systems in commercial use at present, such as Iridium, Inmarsat, Thuraya, Starlink and the like. It is to be noted that although the present disclosure is described mainly with reference to satellites, the NTN according to the present disclosure is not limited to include the satellites.

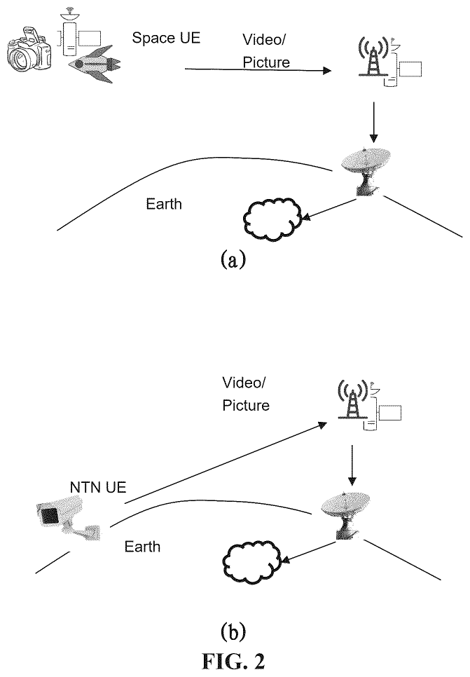

FIG. 2 illustrates two exemplary scenarios of the NTN. As shown in (a) of FIG. 2, for example, in Sony Space Entertainment Program (SSEP), videos or pictures of the space and the Earth are captured by a camera installed on a small satellite, and the captured image data is transmitted to the Earth via a communication satellite, enabling general viewers to observe outer space and the Earth like an astronaut. As also shown in (b) of FIG. 2, a surveillance device installed in a remote region of the Earth is used for environmental detection, for example, and transmits data to a data center located at another location on the Earth via a communication satellite.

While the satellite communication can greatly extend application range of the 5G NR, the satellite link limits large-capacity data transmission for UEs, especially in an uplink direction. By allocating more bandwidth resources, using the MIMO technology, or increasing a transmit power of the UE, for example, the bit error rate may be reduced and the transmission capacity may be increased. However, in the NTN network, these techniques have certain limitations due to factors such as the transmit power of the UE and the remote distance between the UE and the satellite. Especially for a user located at the edge of a NTN cell, the UE needs to switch its cell frequently due to degradation in signal strength, interference from an adjacent cell and the like, as well as possibly rapid movement of the footprint of a satellite beam of the NTN on the ground, so that the uplink transmission rate of the UE is limited, and it is difficult to meet high-speed transmissions for the videos and pictures.

In view of these, the present disclosure proposes application of uplink coordinated multiple points transmission (CoMP) technique in the NTN. The uplink CoMP can be used to increase the capacity of uplink data transmission, and when the bit error rate of uplink data is reduced, the number of retransmissions is also reduced, so that overall effective data transmission delay is also reduced. A principle of the uplink CoMP is that uplink transmission of a certain UE is received by a plurality of adjacent base stations or cells at the same time, and then the base stations or cells improve a success rate of decoding of the received uplink data by a certain algorithm.

However, inventors of the present disclosure have noticed that applying the uplink CoMP in the NTN may face some unique issues, since the NTN has its own characteristics compared to a Terrestrial Network (TN):
(1) highly dynamic connectivity between satellites

A low-orbit satellite typically has very few (e.g., 2 to 4) neighbor satellites, which would greatly limit selectable cooperating base stations when the uplink CoMP is applied. Meanwhile, a low-orbit or medium-orbit satellite has very high flying speed around the Earth, and neighbor satellites may change frequently, which may cause the cooperating satellite base station to be switched frequently;
(2) high-speed movement of satellite beams

A low-orbit or medium-orbit satellite flies very fast around the Earth, and projections of the satellite beams on the ground (or coverages in space) move very fast, which causes coverages of the NTN cells (or base stations) on the ground to be highly dynamic. In addition, since beam measurement of the UE is based on conventional pattern without the uplink CoMP, transmission beam direction of the UE is not optimized when the uplink CoMP is applied;
(3) limited X2 transmission rate between satellites

In general, millimeter waves are used for communication between the satellites, with a communication rate usually lower than 10 Gbps, which results in a limited data transmission rate between the satellites when the uplink CoMP is applied, especially when multiple UEs apply the uplink CoMP under one serving base station.

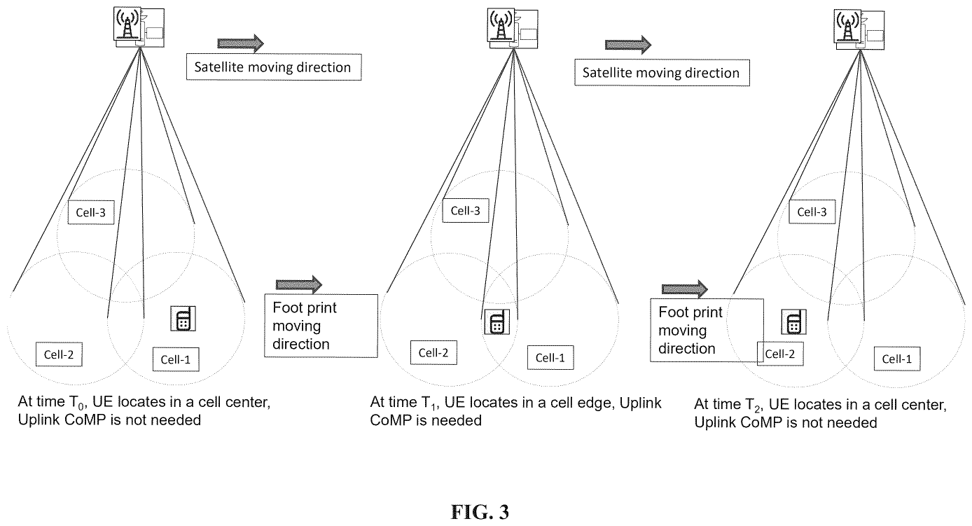

FIG. 3 illustrates a schematic diagram of change of a footprint of a satellite beam with movement of the satellite in the NTN. As shown in FIG. 3, assuming that the satellite base station flies rightwards around the Earth, there are cells Cell-1, Cell-2, and Cell-3 formed by projections of three beams on the Earth's surface. Because of the movement of the satellite, the projections (footprints) of these beams on the Earth's surface also move rightwards at a certain speed. Assuming that the satellite is 600 km off the ground and the projections of the beams on the ground have a diameter of about 50 km, the movement of the beams on the ground has a speed of about 8 km/s, and a UE is covered for about 6 seconds.

In general, the uplink CoMP is used when a UE is at the edge of a cell, that is, where boundaries of several cells are overlapped. As shown in FIG. 3, at time T₀, the UE is located at the center of Cell-1 and does not need to use the uplink CoMP. However, with the rapid movement of the beam footprint, for example, at T₁ a few seconds later, the UE is at a place where the boundaries of the cells Cell-1 and Cell-2 are overlapped, and the uplink CoMP may need to be applied to increase the data transmission capacity for the UE. When the satellite base station continues to move rightwards, the UE completely enters the coverage area of the cell Cell-2 and is located at a center position of Cell-2, and the uplink CoMP is not needed at this moment. These are repeated.

As can be seen from FIG. 3, in the NTN network, under the beam coverage in a non-gaze pattern, the uplink CoMP is needed by the UE intermittently, that is, it is needed for a period of time, not needed for the next period of time, and then needed for the still next period of time. In addition, compared with the TN, the selection of cooperating satellites/cells faces more uncertainty due to the high dynamization of positions of the satellites in the NTN.

Based on the above discussions, the present disclosure provides embodiments of uplink CoMP for the NTN. Various aspects of embodiments of the disclosure are described in detail below.

### Uplink CoMP in NTN

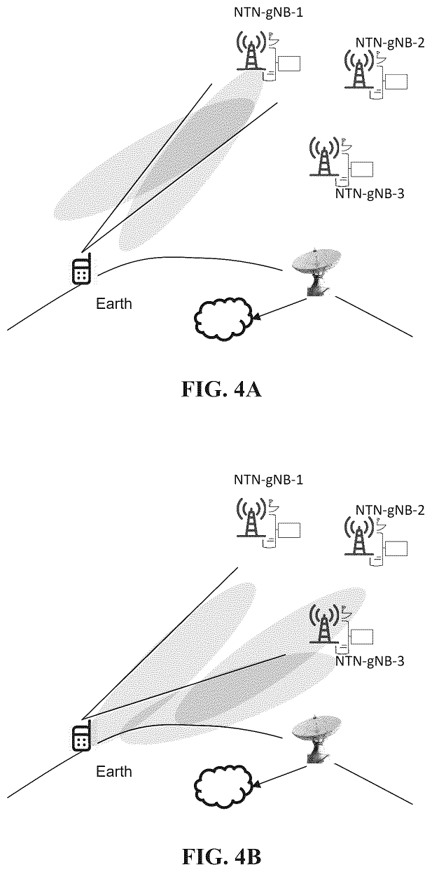

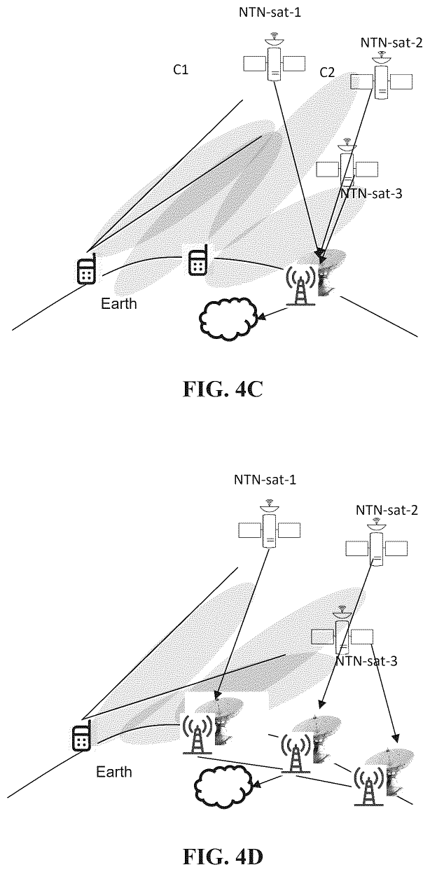

FIGS. 4A-4D illustrate examples of application of the uplink CoMP in the NTN according to the present disclosure. It is to be noted that these examples are a few typical scenarios to illustrate embodiments of the present disclosure and are not intended to limit the application scope of the present disclosure. In FIGS. 4A-4D, the UE is shown as a ground terminal, but this is merely illustrative.

FIG. 4A illustrates an example scenario of the uplink CoMP within a non-transparent satellite base station (hereinafter referred to as “Scenario A”). As used in the present disclosure, a “non-transparent satellite” means that the satellite itself may operate as a base station (e.g., a gNB) that can encode downlink transmissions to the UE and decode uplink transmissions from the UE. In the example shown in FIG. 4A, both of a serving cell of the UE and a cooperating cell participating in the uplink CoMP are subordinate cells of the same non-transparent NTN satellite base station (e.g., NTN-gNB-1). In this scenario, the uplink CoMP does not require data transmission and synchronization between satellite base stations.

FIG. 4B illustrates an example scenario of the uplink CoMP between non-transparent satellite base stations (hereinafter referred to as “Scenario B”). In this example, a serving cell of the UE and cooperating cell(s) participating in the uplink CoMP are subordinate cells of different non-transparent NTN satellite base stations (e.g., NTN-gNB-1, NTN-gNB-2, NTN-gNB-3). In this scenario, the uplink CoMP requires data transmission and synchronization between satellite base stations.

FIG. 4C illustrates an example scenario of the uplink CoMP within a transparent satellite base station. As used in the present disclosure, a “transparent satellite” means that the satellite only forwards downlink transmissions to the UE and uplink transmissions from the UE without encoding or decoding. In this sense, the transparent satellite acts as a relay station between the UE and the ground base station for projecting beams from high altitude to form cells. The example of FIG. 4C can be divided into two sub-scenarios:

Scenario C1: the serving cell and the cooperating cell(s) of the UE are different cells formed by different beams projected by the same transparent satellite (e.g., NTN-sat-1), which is connected to a ground base station. In this scenario, the uplink CoMP does not require data transmission and synchronization between base stations.

Scenario C2: the serving cell and the cooperating cell(s) of the UE are subordinate cells formed by beams projected by different transparent satellites (e.g., NTN-sat-2, NTN-sat-3) connected to the same ground base station. In this scenario, data transmission and synchronization between base stations is not required.

FIG. 4D illustrates an example scenario of the uplink CoMP between transparent satellite base stations (hereinafter referred to as “Scenario D”): the serving cell and the cooperating cell(s) of the UE are subordinate cells formed by beams projected from different transparent satellites (e.g., NTN-sat-1, NTN-sat-2, NTN-sat-3) connected to different ground base stations. The ground base stations may communicate with each other over an inter-base station interface, such as an X2 interface. In this scenario, data transmission and synchronization between base stations is required.

Embodiments of the present disclosure may be practiced in various scenarios. Based on the unique characteristics of the NTN as discussed above, the embodiments of the present disclosure may switch on and switch off the uplink CoMP for a UE at intervals according to the intermittent requirements of the UE for uplink coordinated transmission, including:
the UE reports its geographic location (on the Earth or in space) to the serving cell, and the serving cell collects neighbor cell information;
it is determined whether the uplink CoMP needs to be enabled for the UE or not, for example, when the UE is located in the center of an NTN network cell, the network does not use the uplink CoMP, and when the UE is located where the edges of several NTN network cells are overlapped, the network uses the uplink CoMP;
if the uplink CoMP is enabled, the serving cell selects cooperating base station(s)/cooperating cell(s) and determines a start time and a close time of the uplink CoMP;
the serving cell and the cooperation cell(s) cooperate to receive uplink transmission of the UE from the start time and stop the cooperative reception at the close time;
the above steps are repeated until the UE completes its uplink transmission.

A process of applying the uplink CoMP in the NTN according to embodiments of the present disclosure is described in detail below with reference to the accompanying drawings. For ease of description, when describing network-side behaviors, “cell” and “base station” may be used interchangeably in the present disclosure, such as serving cell and serving base station, or cooperating cell and cooperating base station, although these behaviors are actually performed by entities located in the base station.

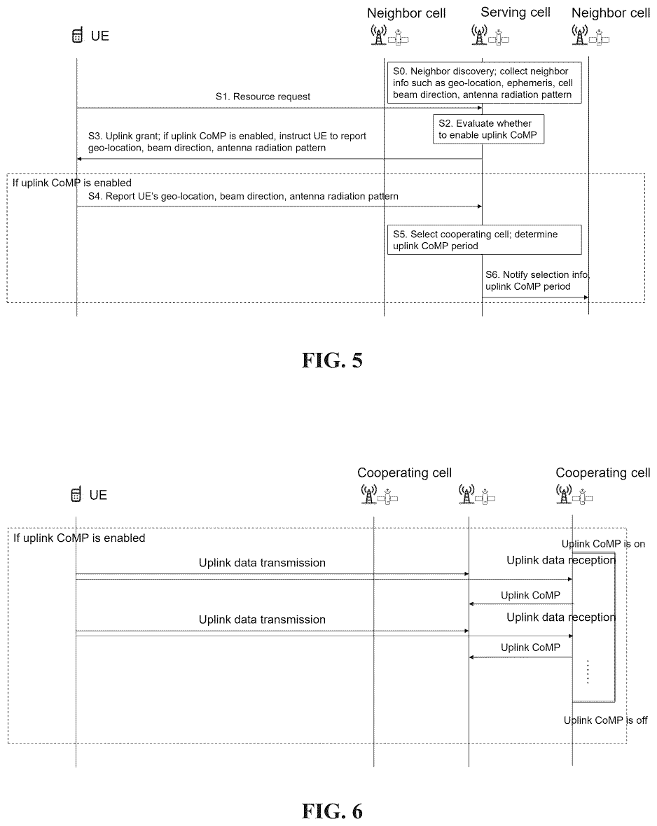

FIG. 5 is a flowchart of the uplink CoMP in the NTN. As a preliminary step, in S0, the serving cell of the UE continuously performs neighbor discovery. In accordance with embodiments of the present disclosure, the “neighbor” may include a neighbor satellite and/or a neighbor cell. For example, for Scenario A in FIG. 4A and Scenario C1 in FIG. 4C, the “neighbor” may include another cell formed by a beam projected in a different direction by the same satellite projecting the serving cell; for Scenario B in FIG. 4B, the “neighbor” may include another base station satellite (and its subordinate cells) proximate to the base station satellite projecting the serving cell, such as a neighbor base station satellite in an X2 connection with the serving base station satellite; for Scenario C2 in FIG. 4C, the “neighbor” may include another transparent satellite (and cells projected by it) associated with the ground base station to which the serving cell is subordinate; for Scenario D in FIG. 4D, the “neighbor” may include another transparent satellite (and its subordinate cells) proximate to the transparent satellite projecting the serving cell. In addition, in S0, the serving cell may also collect various neighbor information, such as but not limited to: geographic locations, ephemerides, cell beam directions, and antenna radiation patterns of the neighbor satellites, and the like.

In S1, the UE having data to transmit may send a Scheduling Request (SR) and/or a Buffer Status Report (BSR) to the serving cell to request time frequency resources for transmission of the user data. In Dynamic Grant resource scheduling mode, the serving cell may dynamically schedule PUSCH using DCI including resource allocation information. In Configured Grant resource scheduling mode, the serving cell may preconfigure available time frequency resources for the UE through RRC layer signaling, so that the UE may directly use the preconfigured time frequency resources to perform PUSCH transmission without requesting the base station to send an uplink grant each time.

Next, in S2, the serving cell evaluates whether to enable the uplink CoMP for the UE. As an example, the evaluation may be based on, for example, one or more of the following: service priority of the UE, amount of data the UE requests to transmit, presence of neighbor cells, and the like. The evaluation may also be based on other factors, so as to decide whether to enable the uplink CoMP for the UE. If it is evaluated in S2 that the uplink CoMP does not need to be enabled for the UE, for example, when the amount of data the UE requests to upload is small, a conventional uplink transmission procedure may be followed.

On the contrary, if it is evaluated in S2 that the uplink CoMP needs to be enabled for the UE, for example, when the amount of data the UE requests to upload is large, then in S3, the serving cell sends an uplink grant to the UE and instructs the UE to report its geographic location, where the geographic location may include a location on the Earth or a location in space. The geographic location may be in any coordinate system or positioning method as long as the UE and the serving cell can reach an agreement. Optionally, the serving cell may also instruct the UE to report its beam direction and antenna radiation pattern.

According to the instruction of the serving cell, in S4, the UE reports its geographic location, beam direction, antenna radiation pattern, and the like.

Subsequently, in S5, the serving cell selects cooperating cell(s) available for the uplink CoMP based on information of the UE, information of the serving cell itself, and the collected information of neighbor cells (which will be described in detail later), and determines an uplink CoMP period.

As an example, the serving cell may determine a coverage range of the serving cell based on the geographic location, beam direction, and/or antenna radiation pattern of the satellite associated with the serving cell, and determine movement information of the serving cell based on the geographic location and the ephemeris of the satellite associated with the serving cell; similarly, the serving cell may determine a coverage range of each of the neighbor cells based on the geographic location, beam direction, and/or antenna radiation pattern of the satellite associated with the neighbor cell, and determine movement information of the neighbor cell based on the geographic location and ephemeris of the satellite associated with the neighbor cell. Based on the geographic location (and optionally, the beam direction and antenna radiation pattern) reported by the UE, the determined coverage ranges and movement information of the serving cell and the neighbor cells, the serving cell may select one or more cooperating cells suitable for the uplink CoMP from the neighbor cells. In addition, the serving cell may also determine an uplink CoMP period, including a start time and an end time of the uplink CoMP. For example, the uplink CoMP period includes the time when the UE is in overlapped portions of the edges of the cells.

In S6, the serving cell may notify the selected neighbor cell (hereinafter, referred to as “cooperating cell”) of information that the neighbor cell is selected as well as information on the uplink CoMP period. Optionally, the serving cell may additionally send, to the cooperating cell, other information that facilitates its reception of the uplink data transmission of the UE, such as time-frequency resource information allocated to the UE and the like.

FIG. 6 illustrates a schematic diagram of uplink transmission performed by the UE in an uplink CoMP period. The UE starts the uplink data transmission using time-frequency resources allocated by the serving cell. A cooperating cell starts receiving the uplink transmission of the UE from the start time of the uplink CoMP. During the uplink CoMP period, the cooperating cell continuously receives the uplink transmission of the UE, and performs cooperative reception of uplink data of the UE with the serving cell of the UE according to a specific algorithm (which will be described below). Upon the end time of the uplink CoMP, the cooperating cell stops the uplink reception for the UE.

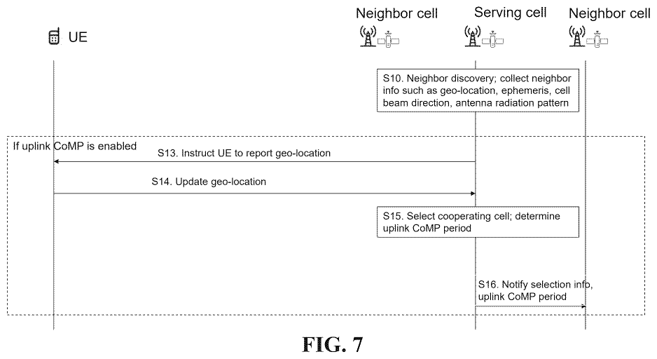

If the data transmission of the UE is not completed, the serving cell may reselect cooperating cell(s) and another uplink CoMP period for the UE. As shown in FIG. 7, in S10, the serving cell continuously performs neighbor discovery and collects various neighbor information such as geographic locations, ephemeris, cell beam directions, antenna radiation patterns, and the like of neighbor satellites.

In S13, the serving cell instructs the UE to update its geographic location. In response to the instruction, the UE reports its current geographic location to the serving cell in S14.

In S15, the serving cell selects cooperating cell(s) available for the uplink CoMP based on the updated geographic location of the UE, information of the serving cell itself, and the collected information of the neighbor cells, and determines an uplink CoMP period. This step may be similar to S5 described above with reference to FIG. 5 and is not repeated here.

In S16, the serving cell may notify the selected neighbor cell (hereinafter, referred to as “cooperating cell”) of information that the neighbor cell is selected as well as information on the uplink CoMP period. Optionally, the serving cell may additionally send, to the cooperating cell, other necessary information required for receiving uplink data transmission of the UE.

With the above described process, the NTN can switch between using and not using the uplink CoMP as needed based on the UE location, to meet the intermittent characteristic of the requirement of the UE on the uplink CoMP.

A procedure of the uplink data transmission is briefly described here. The uplink data transmission from the UE to the base station is done through a Physical Uplink Shared Channel (PUSCH). The 5G NR generally supports two uplink transmission schemes: codebook-based transmission and non-codebook-based transmission. For the codebook-based transmission, the base station provides the UE with a Transmit Precoding Matrix Indication (TPMI) in Downlink Control Information (DCI), which can be used by the UE to select a transmit precoder for the PUSCH from a codebook. For the non-codebook based transmission, the UE determines its transmit precoder for the PUSCH based on a wideband SRS Resource Indicator (SRI) field in a DCI.

User data from a MAC layer will be referred to as a “Transport Block (TB)” and will need to undergo a series of uplink physical layer processing in order to be mapped to a transport channel at a physical layer. The uplink physical layer processing generally includes: cyclic Redundancy Check (CRC) addition to the transport block, code block segmentation and code block CRC addition, channel coding, physical layer HARQ processing, rate matching, scrambling, modulation, layer mapping, transform precoding and precoding, and mapping to allocated resources and antenna ports.

By means of various signal processing functions at the physical layer, a bit stream as the user data is encoded and modulated into OFDM symbols and transmitted by an antenna array to a corresponding satellite using allocated time-frequency resources. The base station can decode the user data through an inverse of the above signal processing.

The uplink CoMP between the serving cell and the cooperating cell(s) may employ various algorithms including, but not limited to: Joint Reception (JR), Hard Decision Dynamic Cell Selection (HDDCS), Soft Information Combining (SIC), or the like.

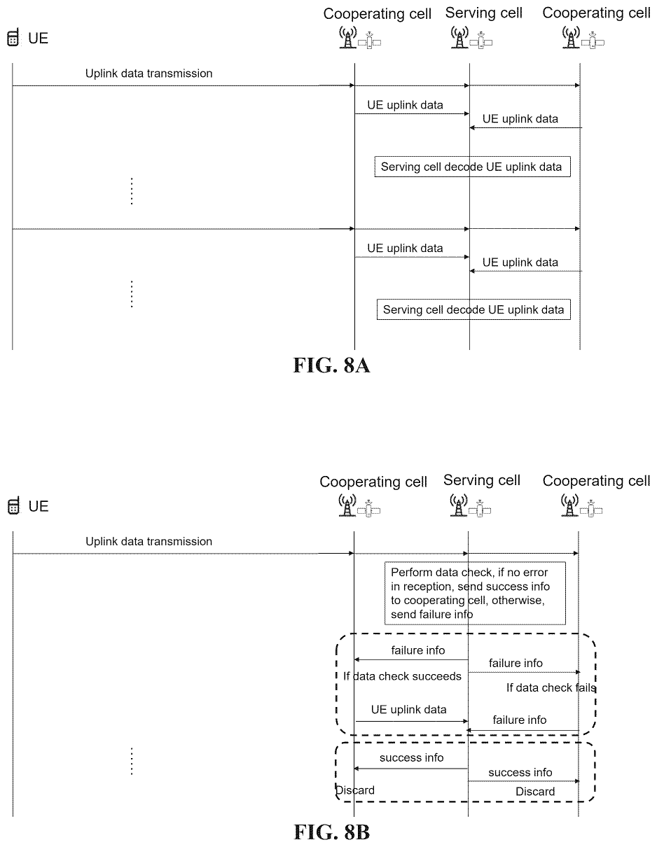

FIG. 8A illustrates an example of the uplink CoMP based on the joint reception algorithm. As shown in FIG. 8A, the serving cell and the cooperating cells cooperate to receive uplink data of the UE during the uplink CoMP period as described with reference to FIGS. 5-7. Then, the cooperating cells send the received uplink data of the UE to the serving cell. The serving cell performs joint decoding on the UE uplink data received by the serving cell itself and the UE uplink data received by the cooperating cells to obtain the uplink data of the UE.

FIG. 8B illustrates an example of the uplink CoMP based on the hard decision dynamic cell selection algorithm. As shown in FIG. 8B, the serving cell and the cooperating cells cooperate to receive uplink data of the UE during the uplink CoMP period as described with reference to FIGS. 5-7. The serving cell performs data error check on the UE uplink data received by itself. If there is no error in the reception, the serving cell sends information indicating successful reception to the cooperating cells, otherwise, the serving cell sends information indicating failed reception. If the cooperating cell receives the information indicating successful reception, it discards the received UE uplink data. If the cooperating cell receives the information indicating failed reception, the cooperating cell performs a check on the UE uplink data received by it, and sends the received UE uplink data to the serving cell if there is no error in the reception; or sends information indicating reception failure to the serving base station if there is an error. When all of the cooperating cells return the information indicating reception failure to the serving cell, which indicates that all the cells participating in the uplink CoMP have failed in the reception, the serving cell returns a Negative Acknowledgement (NACK) for the PUSCH transmission to the UE, and the UE retransmits the data until the UE data is correctly received or the maximum number of retransmissions is reached.

### Selection of Cooperating Base Station(s)/Cell(s)

According to embodiments of the present disclosure, when the uplink CoMP is applied in an NTN network, a serving cell may select a satellite, a base station, or even a cell suitable for cooperation. Selection methods of the cooperating base station(s)/cell(s) of the present disclosure are described below with respect to the scenarios illustrated in FIGS. 4A-4D.

### (1) For Uplink CoMP Within a Satellite/Base Station

In Scenario A described with reference to FIG. 4A and Scenario C1 described with reference to FIG. 4C, both of the serving cell and the cooperating cell(s) are from the same satellite and base station. In such scenarios, factors for selecting a cooperating cell may include one or more of: 1) proximity, for example, the cooperating cell should be a neighbor cell of the serving cell; 2) signal quality, for example, the quality of signals of the UE received by the cooperating cell should be better than a predetermined threshold Q1 for at least a predetermined time T1; 3) potential coverage time, for example, it can serve as a cooperating cell for the longest time among all neighbor cells.

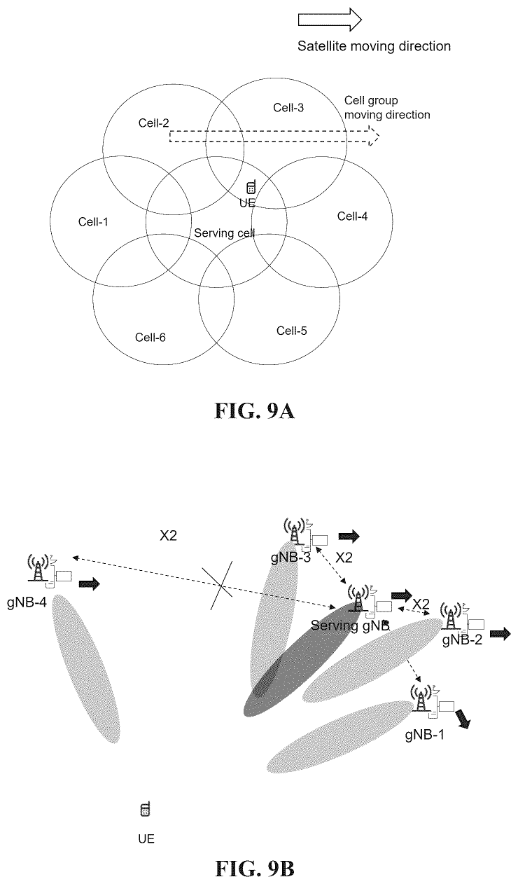

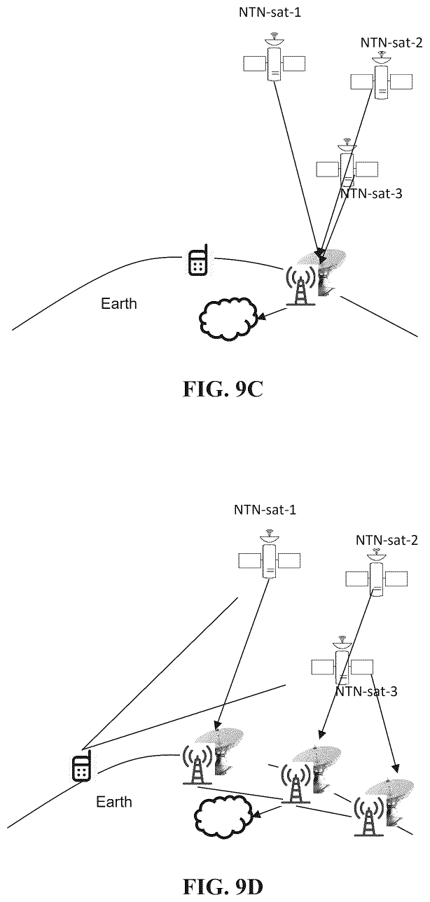

FIG. 9A is a schematic diagram of the cooperating cell selection suitable for such scenarios. In an example shown in FIG. 9A, the neighbor cells of the UE's serving cell include Cell-1, Cell-2, . . . , and Cell-6 projected by the same satellite. It is assumed that the signal quality of the UE is better than a predetermined threshold for more than T1 only on cells Cell-2, Cell-3, and Cell-4, and thus these three cells may be candidates for the cooperating cell. In addition, the serving cell determines potential coverage times of the three cells for the UE based on the geographic location of the UE, the coverage range (e.g., based on the beam direction, antenna radiation pattern of the neighbor cell) and the movement information (e.g., based on the ephemeris of the satellite) of each of the neighbor cells. For example, in FIG. 9A, the cell Cell-4 is moving away from the UE, while the cells Cell-2 and Cell-3 are covering or approaching the UE, and thus the serving cell may determine that the potential coverage time of the cells Cell-2 and Cell-3 is longer than the potential coverage time of the cell Cell-4. According to requirements of the uplink CoMP, the serving cell may finally select two cells Cell-2 and Cell-3 with the longest potential coverage time as cooperating cells.

According to an embodiment of the present disclosure, specific seps of the method for selection a cooperating cell may include:
1) the serving cell determines its set of neighbor cells {nC1, nC2, nC3, . . . }, 1=<i<=N1, where any neighbor cell nCi is formed by projection from the sample satellite, and belongs to the same satellite base station (Scenario A) or the same ground base station (Scenario C1);
2) the serving cell acquires a geographic location GL_{UE} of the UE;
3) based on GL_{UE}, and beam direction and antenna radiation pattern of the neighbor cell nCi, the serving cell determines a candidate cooperating cell set {cC1, cC2, cC3, . . . }, i<=N2, wherein N2<=N1;
4) the base station instructs the serving cell and each of the candidate cooperating cells to measure uplink signal quality of the UE, such as Reference Signal Received Power (RSRP). If the quality (such as RSRP) of signal of the UE received by a candidate cooperating cell is detected to be better than a predetermined threshold Q1 for at least a predetermined time T1, this cell has potential to be an uplink CoMP cooperating cell for the UE;
5) the serving cell collects signal quality measurements for all of the candidate cooperating cells, and for those cells that have received the signal with a quality better than Q1 for at least the time T1, the serving cell evaluates their potential coverage times over the UE;
6) finally, the serving cell selects N_{F} final cooperating cells, that is, those candidate cooperating cells having the longest potential coverage time.

It should be noted that the above sequence of steps may be illustrative, and the order of some steps may be exchanged or performed concurrently, for example, the serving cell may consider the potential coverage time first and then the signal quality, as long as the cooperating cell meeting the requirements can be selected.

### (2) For Uplink CoMP Between Satellite Base Stations

In Scenario B described with reference to FIG. 4B, the serving cell and the cooperating cell(s) may come from different satellite base stations. In this scenario, factors for selecting a cooperating cell may include one or more of: 1) proximity, e.g., the cooperating satellite base station should be a one-hop neighbor node of the serving satellite base station; 2) connection time, that is, the cooperating satellite base station should have a connection with the serving satellite base station that meets the requirement for quality and lasts a long enough duration; 3) signal quality, for example, the cooperating satellite base station needs to be able to receive signals of the UE, and the received signal quality meets the requirement; 4) potential coverage time, for example, it can serve as a cooperating cell for the longest time among all neighbor cells.

Based on the above principles, a cooperating satellite base station that maintains a moving direction the same as or similar to that of the serving satellite base station is most likely to be selected. The moving directions of these cooperating satellite base stations and the serving satellite base station can be known from ephemerides of the satellites.

FIG. 9B is a schematic diagram of the cooperating cell selection suitable for such a scenario. It is assumed that there are four satellite base stations gNB-1, gNB-2, gNB-3, and gNB-4 around the serving satellite base station (e.g., serving gNB). However, only gNB-1, gNB-2, and gNB-3 are one-hop neighbor nodes of and have an X2 interface connection with the serving satellite base station, while gNB-4 is not a one-hop neighbor node of the serving satellite base station and does not have an X2 interface connection with the serving base station. Accordingly, in the selection process, gNB-4 is excluded. Of the remaining three satellite base stations, gNB-1 has a different moving direction than the serving satellite base station, and duration of the connection with the serving base station satellite may not be long enough to meet the requirement for uplink transmission of the UE, and thus is excluded. gNB-2 has the same moving direction as the serving base station satellite, can receive the signal of the terminal and meet the quality requirement, and may be selected. It is assumed that although gNB-3 has the same moving direction as the serving satellite base station and can maintain a long connection with the serving satellite base station, gNB-3 cannot receive the UE's signal and thus is also excluded. Consequently, gNB-2 can be selected finally as the cooperating satellite base station.

In the example of FIG. 9B, if gNB-2 has multiple subordinate cells, all of the multiple cells may be selected as cooperating cells for uplink CoMP of the UE. Preferably, the serving cell may select a cooperating cell that is most suitable for the uplink CoMP of the UE based on geographic location of the UE, coverage range (e.g., based on beam direction and antenna radiation pattern of the cell) and movement information (e.g., based on ephemeris of the satellite) of each of the cells of gNB-2.

According to an embodiment of the present disclosure, specific steps of the method for selecting a cooperating satellite base station may include:
1) the serving satellite base station performs neighbor discovery, and finds a set of one-hop neighbor satellite base stations Sn;
2) the serving satellite base station establishes an X2 connection with the one-hop neighbor satellite base stations (if there was no X2 connection before);
3) the serving satellite base station requires the one-hop neighbor satellite base stations to receive and measure signal quality, such as RSRP, of uplink signal of the UE;
4) each of the neighbor satellite base stations reports the signal quality of the uplink signal of the UE to the serving satellite base station;
5) the serving satellite base station selects Nc neighbor satellite base stations with the best signal quality measurements;
6) based on the ephemerides of the Nc neighbor satellite base stations, the serving satellite base station estimates the time that each neighbor satellite base station can maintain a connection with the serving base station;
7) based on geographic location of the UE, beam direction and antenna radiation pattern of each of the neighbor satellite base stations, the serving satellite base station evaluates a potential coverage time of each of the neighbor satellite base stations over the UE;
8) the serving satellite base station selects Nf neighbor satellite base stations that can have the longest connection time with the serving satellite base station and/or the longest potential coverage time as cooperating satellite base stations.

By the above steps, the selection can be made on the satellite base station level. However, when a neighbor satellite base station has multiple subordinate cells, the comparison/ranking may be embodied on the cell level, that is, one or more particular cells are selected as the cooperating cells based on at least the measurements of uplink signal of the UE, the potential coverage times over the UE, and the connection times with the serving satellite base station of the cells of the neighbor satellite base station.

### (3) For Uplink CoMP Within Transparent Satellites and Ground Base Station

In Scenario C2 described with reference to FIGS. 4C and 9C, the serving cell and the cooperating cell(s) may come from different transparent satellites but belong to the same ground base station. In such a scenario, multiple transparent satellites are connected to the same ground base station, each of the transparent satellite transmits one or more covering beams, and each of the covering beam may be a cell. In this scenario, factors for selecting a cooperating cell may be one or more of: 1) proximity, for example, the cooperating cell should be a neighbor cell of the serving cell; 2) signal quality, for example, the transparent satellite of the cooperating cell can receive uplink signal of the UE and a certain quality requirement is met; 3) potential coverage time, the beam of the transparent satellite of the cooperating cell can cover the UE as long as possible.

According to an embodiment of the present disclosure, the method for selecting a cooperating cell may include:
1) based on geographic location of the UE, and ephemerides of transparent satellites connected to the ground base station, the serving cell determines a set of transparent satellites that may provide cooperating cell(s);
2) the serving cell requests cells of the transparent satellites that may serve as cooperating cells to receive uplink signals of the UE, and selects Nc of the cells with the best signal reception quality as candidate cooperating cells (transparent satellites);
3) based on geographic location of the UE, and beam direction, antenna radiation pattern and the like of the candidate cooperating cells, the serving cell evaluates the potential coverage time of each of the candidate cooperating cells over the UE;
4) the serving cell finally determines Nf cells capable of covering the UE the longest as the cooperating cells.

### (4) For Uplink CoMP Between Transparent Satellites and Ground Base Stations

In Scenario D described with reference to FIGS. 4D and 9D, a plurality of adjacent transparent satellites are connected to different ground base stations, and each of the transparent satellites transmits one or more beams to form one or more cells. In such a scenario, principles of selecting a cooperating base station may include one or more of: 1) proximity, for example, the serving base station (ground) have an X2 interface connection with the cooperating base station (ground); 2) signal quality, for example, a cell or cells of the cooperating base station can receive signals of the UE with a signal quality better than a set threshold; 3) potential coverage time, for example, the longer to serve as the cooperative base station, the better (the moving direction of the transparent satellite(s) of the cooperating base station is as identical or close to the moving direction of the transparent satellite of the serving base station as possible).

According to an embodiment of the present disclosure, the method for selecting a cooperating base station may include the steps of:
1) The serving base station exchanges information of respective transparent satellites with other ground base stations via an X2 interface, wherein the information comprises geographic location, beam direction(s) of subordinate cell(s), antenna radiation pattern, ephemeris and the like;
2) the serving base station determines potential cooperating base stations according to geographic location of the UE and the exchanged information;
3) the serving base station requires the potential cooperating base stations to receive uplink signals of the UE (through corresponding transparent satellites);
4) the serving base station selects Nc potential cooperating base stations with the best signal quality as candidate cooperating base stations;
5) based on ephemerides, beam directions of subordinate cells, and antenna radiation patterns of transparent satellites corresponding to the candidate cooperating base stations, geographic location of the UE, and other information, the service base station evaluates potential coverage times of the Nc candidate cooperating base stations over the UE;
6) the serving base station finally determines Nf cooperating base stations that have the longest potential coverage time over the UE.

By the above steps, the selection can be made on the ground base station level. However, when a ground satellite base station has multiple subordinate cells, the comparison/ranking may be embodied on the cell level, that is, one or more cells are selected as the cooperating cells based on at least the measurements of uplink signals of the UE, and the potential coverage times over the UE of the cells of the ground base station.

### Optimization of UE Transmit Beam

To combat large path impairments existing in the channel, the satellites and the UE may have multiple antennas that can form a spatial beam with narrow directivity by beamforming to provide strong power coverage in a particular direction. Typically, the satellites and the UE can determine transmission beams and reception beams to be used through beam scanning.

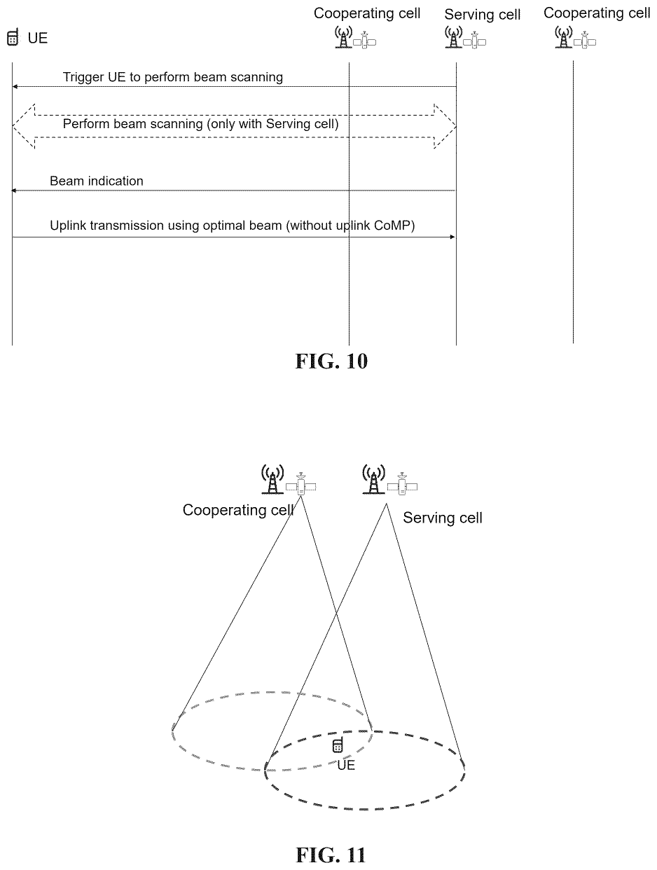

FIG. 10 illustrates a flowchart for determining beams for uplink transmission in a case where the uplink CoMP is not applied. As shown in FIG. 10, the serving cell may trigger the UE to perform the beam scanning with a preconfigured set of reference signal resources. It is assumed that the UE transmits n_{r_UL} uplink reference signals (e.g., Sounding Reference Signals (SRSs)) to the serving cell through each of its n_{t_UL} transmission beams. In this way, the serving cell receives a total of n_{t_UL}×n_{r_UL} uplink reference signals through its n_{r_UL} reception beams. The serving cell measures the n_{t_UL}×n_{r_UL} uplink reference signals, for example, measures their RSRPs or the like, and indicates a reference signal with the best measurement to the UE, for example, by means of a Transmission Configuration Indication (TCI) state, so that the UE can perform the uplink transmission using an uplink transmission beam that transmitted the indicated reference signal in the beam scanning process.

The UE transmission beam thus determined may guarantee optimal reception by the serving cell, however, optimal reception by the cooperating cell may not necessarily be guaranteed after the uplink CoMP is applied. FIG. 11 illustrates a schematic diagram of projecting a cooperating cell and a serving cell by different satellite base stations, respectively. The UE transmission beam determined by the beam scanning between the UE and the serving base station may be well aligned with the serving base station's channel direction, and its beam direction is assumed to be D1. In conventional uplink CoMP, the transmission behavior of the UE is not affected, and the UE will always transmit uplink data in the optimal direction D1 towards the serving base station. However, in the uplink CoMP, there are multiple base stations or cells receiving the uplink data of the target terminal, so the beam direction D1 directed to only the serving base station/cell may result in non-optimized reception of the cooperating base station(s)/cell(s). Particularly in the satellite communication, beam direction of a cooperating base station/cell for the coordinated multi-point transmission needs to be dynamically adjusted due to high-speed movement of the satellite.

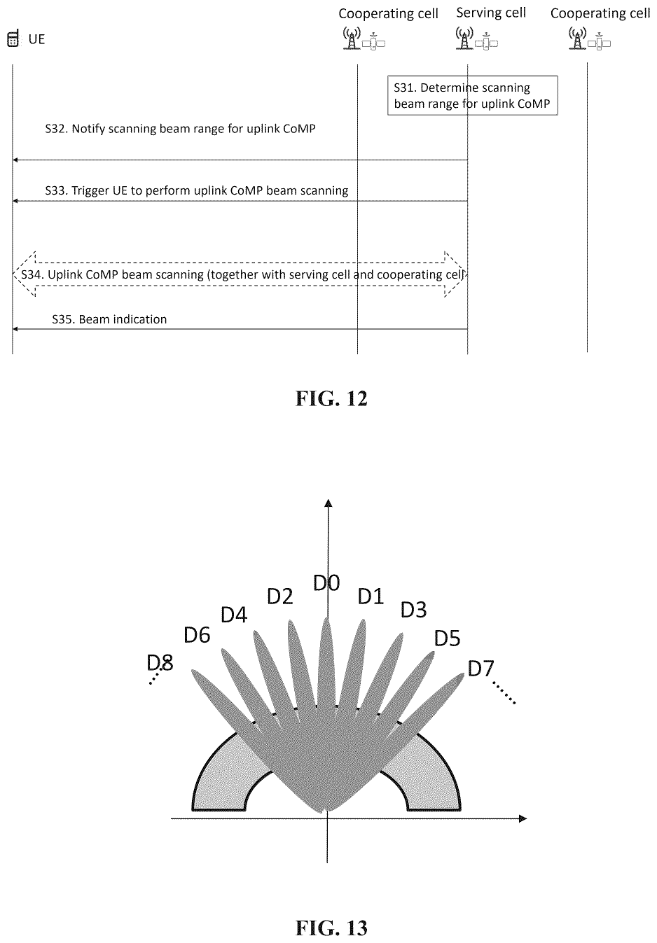

According to an embodiment of the present disclosure, in the uplink CoMP process, the transmission beam direction of the UE is dynamically adjusted to obtain optimized joint reception and obtain the best transmission performance, especially for Scenario B shown in FIG. 4B, Scenario C2 shown in FIG. 4C, and Scenario D shown in FIG. 4D. FIG. 12 illustrates a flowchart for determining beams for uplink transmission in a case where the uplink CoMP is applied in the NTN.

First, in S31, the serving cell may determine a scanning beam range for the uplink CoMP. The scanning beam range may be determined by the serving cell based on geographic location of the UE, information of the serving cell (e.g., geographic location, beam direction, and antenna radiation pattern of the satellite where it is located) and information of the cooperating cells (e.g., geographic location, beam direction, antenna radiation pattern of the satellites where they are located). As an example, the scanning beam range may be from a beam codebook preconfigured for the UE, that is, belong to a subset of the beam codebook. A beam codebook is a set formed by beams with different directions, which may be identified, for example, by an SRS resource set (SRSResourceSet) or a CSI-RS resource set (CSI-RSResourceSet). The scanning beam range may be determined, for example, as a set of several beams between a direction in which the UE is aligned with the satellite projecting the serving cell (e.g., determined based on the geographic location of the UE and the geographic location of the satellite projecting the serving cell) and a direction in which the UE is aligned with the satellite projecting the cooperating cell (e.g., determined based on the geographic location of the UE and the geographic location of the satellite projecting the cooperating cell).

In S32, the serving cell may notify the UE of the determined scanning beam range for the uplink CoMP. Such notification may be achieved, for example, by a newly defined field in Downlink Control Information (DCI). As an example, a field in the DCI may enumerate beams in the scanning beam range (e.g., by SRSResourceIDs or CSI-RSResourceIDs), or describe an index range of beams in the scanning beam range.

FIG. 13 illustrates an example of the scanning beam range according to an embodiment of the present disclosure. It is assumed that the UE is preconfigured with a set of beams {D0, D1, D2, . . . }, and the beams may be indexed in the order shown in FIG. 13. Then, by means of newly added bits or reserved bits in the DCI, the serving cell may notify the UE of the scanning beam range for the uplink CoMP. The number of required bits may depend on the number of beams in the preconfigured set of beams. For example, a minimum of 4 bits may be used for the beams D0-D8 in FIG. 13. These bits are all 0, e.g., “0000”, if the uplink CoMP is not applied. Otherwise, bit values which are not all zeros are used for indicating the beam scanning range of the UE for the uplink CoMP. For example, “0110” may be used to indicate that the beams D0-D6 are used as the scanning beam range, in which case the UE interprets “0110” as an index of the ending beam D6 of the scanning beam range (i.e., 0110=6), while the starting beam of the scanning beam range is D0 by default. It should be noted that the notification method of the scanning beam range may not be limited thereto, and may even not be limited to using the DCI, for example, MAC CE may also be used.

In S33, the serving cell triggers the UE to perform beam scanning for the uplink CoMP (e.g., by a DCI), and in response to this trigger, the UE may perform the beam scanning with the serving cell and the cooperating cells in S34. In particular, the UE may transmit a reference signal, such as SRS, using each beam in the scanning beam range, and both the serving cell and the cooperating cells receive and measure the reference signals transmitted by the UE. The cooperating cells feed the measurements back to the serving cell. The serving cell may determine an optimal UE transmission beam for joint reception of the serving cell and the cooperating cells based on its own measurements and the measurements of the cooperating cells.

In S35, the serving cell indicates this optimal transmission beam to the UE, for example, by means of a TCI state associated with the transmission beam. Subsequently, during the uplink CoMP period, the UE may transmit uplink data using the optimal transmission beam notified by the serving cell. The serving cell and the cooperating cells may achieve reception using reception beams corresponding to the optimal transmission beam of the UE in S34. In this way, beam optimization in the uplink CoMP is achieved.

Considering the highly dynamic locations of the satellites in the NTN, the serving cell may repeat the process in FIG. 12 at intervals or when the UE's signal quality falls below a certain threshold, so as to re-optimize the beams suitable for the uplink CoMP.

As described above, requirements of the UE for the uplink CoMP in the NTN network are intermittent. In a period of time after the uplink CoMP is implemented, the UE may be located at the center of a certain cell and the uplink CoMP is not needed. At this time, the uplink CoMP is switched off, and only the serving cell receives uplink signals of the UE, and if the UE still uses the beam optimized for the uplink CoMP, the optimal reception effect may not be achieved. Thus, according to an example of the present disclosure, after the uplink CoMP is switched off, the UE and the serving cell may perform the process shown in FIG. 10, such that the UE may use a beam optimized for the non-CoMP scenario to perform the uplink transmission.

### Reception Time Adjustment for Uplink CoMP

In uplink CoMP for the NTN, the distances from the UE to different satellites may differ greatly, so that Time Advances (TAs) from the UE to the different satellites (transparent or non-transparent) may be different.

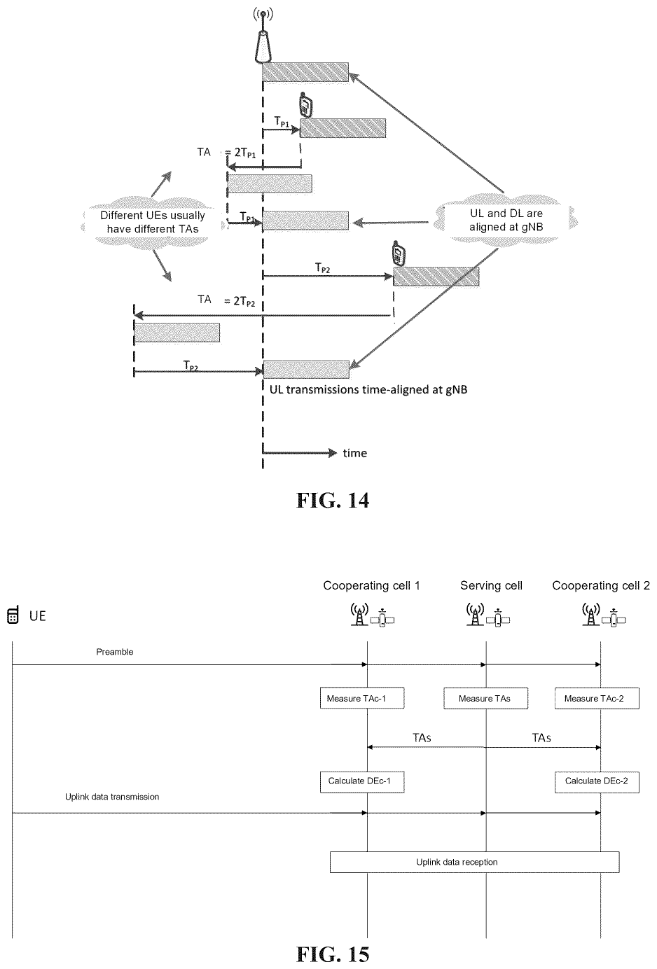

The time advance is used for uplink transmission of the UE, which means that a system frame for transmitting uplink data by the UE is advanced by a certain time compared with a corresponding downlink frame. FIG. 14 illustrates a schematic diagram of the time advance. As shown, the downlink frame transmitted by the base station is received by the UE after T_{P1}, where T_{P1} corresponds to a propagation time of electromagnetic waves between the base station and the UE. In order to align the uplink frame transmitted by the UE with the downlink frame at the base station, the UE may advance the transmission time of the uplink frame by 2T_{P1}. Different UEs typically have different time advances. For example, as shown in FIG. 14, the time advance of another UE may be 2T_{P2}. The specific the time advance amount is calculated by the base station according to a random access preamble sent by the UE, and then notified to the UE through a Timing Advance Command (TAC).

However, in the uplink CoMP, a UE does not know the presence of other cooperating satellites when transmitting data to the serving base station. In this case, the UE performs the uplink data transmission using only the TA suitable for the serving base station, and cannot individually transmit the uplink data using the TA suitable for each cooperative satellite. This may result in time misalignment at some or all of the cooperating base stations.

In this regard, an embodiment of the present disclosure may adjust respective reception time (RT) for each cooperative base station/cell. FIG. 15 illustrates a flow chart for adjusting the reception time of a cooperating cell according to an embodiment of the present disclosure.

As shown in FIG. 15, first, the UE may transmit preambles to the serving cell and respective cooperating cells. Based on the received preamble, the serving cell and the cooperating cells measure the time advance with the UE, respectively, and assuming that the measured result is TA_{c-i}, i=1, 2; , . . . K (K is the number of cooperating cells), for example, in FIG. 15, a cooperating cell 1 measures TA_{c-1}, the serving cell measures TAₛ, and a cooperating cell 2 measures TA_{c-2}.

The serving cell may send the measured time advance value TAₛ to each of the cooperating cells. Each cooperating cell infers respective reception delay for the uplink transmission of the UE, DE_{c-i}=TAₛ-TA_{c-i}, i=1, 2, . . . K.

Finally, in the uplink CoMP, each of the cooperating cells delays (or advances) its own reception window by the absolute value abs(DE_{c-i}) when receiving uplink data of the UE. When DE_{c-i} is positive, the cooperating cell delays by the absolute value abs(DE_{c-i}), and when DE_{c-i} is negative, advances by the absolute value abs(DE_{c-i}). In other words, in the flow of uplink CoMP described with reference to FIGS. 5 and 7, the uplink CoMP period notified by the serving cell to the cooperating cell(s) may be based on a local clock of the serving cell, and the cooperating cell(s) may adjust the start time and the end time of cooperative reception according to the reception delay DE_{c-i} as calculated above.

### Electronic Device and Communication Method

Electronic devices and communication methods that can apply the embodiments of the present disclosure are described below.

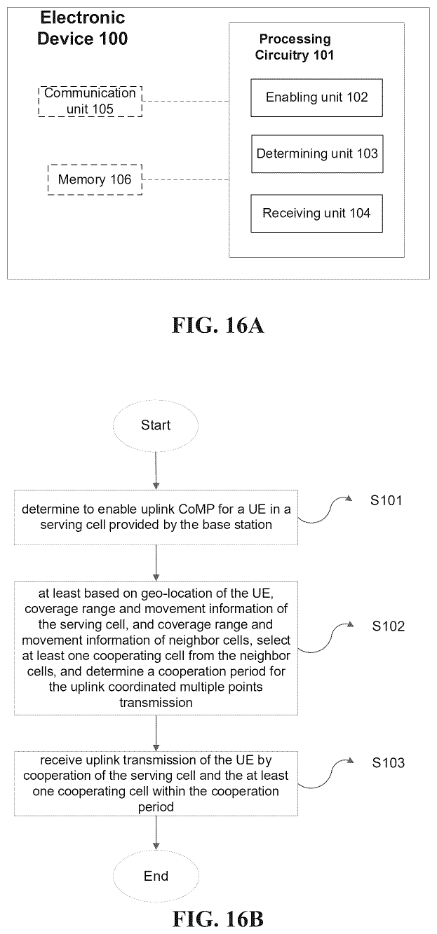

FIG. 16A is a block diagram illustrating an electronic device 100 according to the present disclosure. The electronic device 100 may be a component functioning as a serving base station (e.g., a satellite base station or a ground base station) of a UE in an NTN.

As shown in FIG. 16A, the electronic device 100 includes processing circuitry 101. The processing circuitry 101 includes at least an enabling unit 102, a determining unit 103, and a receiving unit 104. The processing circuitry 101 may be configured to perform the communication method shown in FIG. 16B. The processing circuitry 101 may refer to various implementations of a digital circuitry, an analog circuitry, or a mixed signal (combination of analog signal and digital signal) circuitry that performs functions in a computing system.

The enabling unit 102 in the processing circuitry 101 is configured to enable uplink CoMP for a UE in a serving cell provided by the base station, that is, to perform step S101 in FIG. 16B.

In response to enabling the uplink CoMP for the UE by the enabling unit 102, the determining unit 103 is configured to, at least based on geographic location of the UE, coverage range and movement information of the serving cell, and coverage range and movement information of neighbor cells, select at least one cooperating cell from the neighbor cells, and determine a cooperation period for the uplink CoMP, that is, to perform step S102 in FIG. 16B. The geographic location of the UE may be reported by the UE, the coverage range of the serving cell and the neighbor cells may be based on cell beam direction and antenna radiation pattern, and the movement information may be based on ephemeris of an associated satellite.

Preferably, in selecting the cooperating cell, the determining unit 103 can consider one or more factors among signal quality measurements of an uplink signal of the UE by the cell, potential coverage time of the cell over the UE, and connection time between a satellite where the serving cell is located and a satellite base station where the cooperating cell is located.

The receiving unit 104 is configured to receive uplink transmission of the UE by cooperation of the serving cell and the at least one cooperating cell within the cooperation period, that is, to perform step S103 in FIG. 16B.

Preferably, the processing circuitry 101 may further include a unit (not shown) for optimizing beams for the uplink CoMP. The unit is configured to determine a scanning beam range for the UE, indicate the determined scanning beam range to the UE, acquire signal quality of an uplink signal transmitted by the UE with each of transmission beams in the scanning beam range measured by the serving cell and the cooperating cell, and based on the measurements, determine a transmission beam of the UE for the uplink CoMP.

The electronic device 100 may further include a communication unit 105. The communication unit 105 may be configured to communicate with the UE, another satellite or base station under the control of the processing circuitry 101. In one example, the communication unit 105 may be implemented as a transmitter or transceiver, including communication components such as antenna arrays and/or radio frequency links. The communication unit 105 is depicted with a dashed line, since it may also be located outside the electronic device 100.

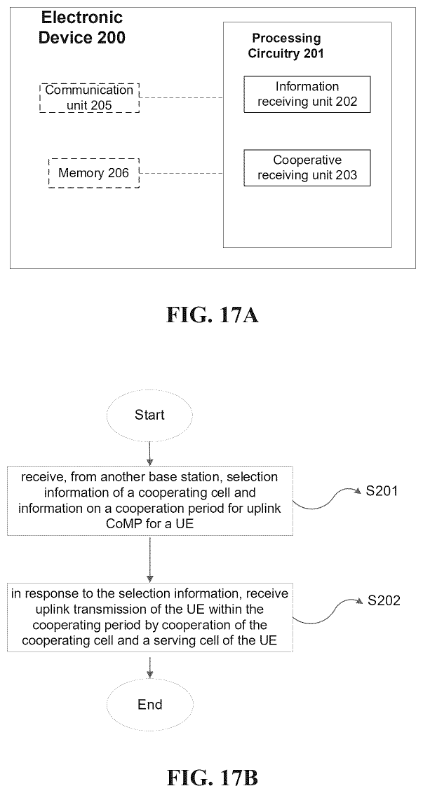

The electronic device 100 may also include a memory 106. The memory 106 may store various data and instructions, such as programs and data for operation of the electronic device 100, various data generated by the processing circuitry 101, various control signaling or traffic data received or transmitted by the communication unit 105, and the like. The memory 106 is depicted with a dashed line, since it may also be located within the processing circuitry 101 or outside the electronic device 100.
FIG. 17A is a block diagram illustrating an electronic device 200 according to the present disclosure. The electronic device 200 may be a component functioning as a cooperating base station (e.g., a satellite base station or a ground base station) of a UE in an NTN.

As shown in FIG. 17A, the electronic device 200 includes processing circuitry 201. The processing circuitry 201 includes at least an information receiving unit 202, and a cooperative receiving unit 203. The processing circuitry 201 may be configured to perform the communication method shown in FIG. 17B. The processing circuitry 201 may refer to various implementations of a digital circuitry, an analog circuitry, or a mixed signal (combination of analog signal and digital signal) circuitry that performs functions in a computing system.

The information receiving unit 202 may be configured to receive, from another base station, selection information of a cooperating cell and information on a cooperation period for uplink CoMP for the UE, that is, to perform step S201 in FIG. 17B. The another base station is a serving base station that enables the uplink CoMP for the UE. The selection information received by the information receiving unit 202 indicates that a cell of this base station is selected as the cooperative cell for the uplink CoMP, and the cooperation period indicates a time period during which the serving cell and the cooperating cell perform uplink coordinated multiple points transmission together, and may be represented by a start time and an end time.

The cooperative receiving unit 203 may be configured to in response to the selection information, receive uplink transmission of the UE within the cooperating period by cooperation of the cooperating cell and the serving cell of the UE, that is, to perform step S202 in FIG. 17B. Preferably, the cooperative receiving unit 203 can delay or advance its reception window based on a reception delay determined based on time advances between the serving cell and the UE and between the cooperating cell and the UE.

The electronic device 200 may further include a communication unit 205. The communication unit 205 may be configured to communicate with the UE, another base station or satellite under the control of the processing circuitry 201. In one example, the communication unit 205 may be implemented as a transmitter or transceiver, including communication components such as antenna arrays and/or radio frequency links. The communication unit 205 is depicted with a dashed line, since it may also be located outside the electronic device 200.

The electronic device 200 may also include a memory 206. The memory 206 may store various data and instructions, such as programs and data for operation of the electronic device 200, various data generated by the processing circuitry 201, various control signaling or traffic data received or transmitted by the communication unit 205, and the like. The memory 206 is depicted with a dashed line, since it may also be located within the processing circuitry 201 or outside the electronic device 200.

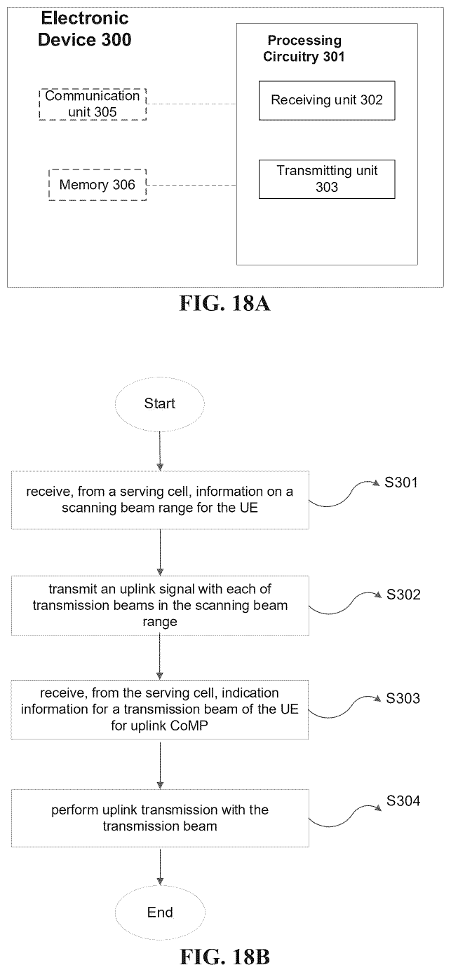

FIG. 18A is a block diagram illustrating an electronic device 300 according to the present disclosure. The electronic device 300 may be a component of a UE in an NTN.

As shown in FIG. 18A, the electronic device 300 includes processing circuitry 301. The processing circuitry 301 includes at least a receiving unit 302, and a transmitting unit 303. The processing circuitry 301 may be configured to perform the communication method shown in FIG. 18B. The processing circuitry 301 may refer to various implementations of a digital circuitry, an analog circuitry, or a mixed signal (combination of analog signal and digital signal) circuitry that performs functions in a computing system.

The receiving unit 302 may be configured to receive, from a serving cell, indication information on a scanning beam range for the UE, that is, to perform step S301 in FIG. 18B. The scanning beam range may be a subset of a beam set preconfigured to the UE.

The transmitting unit 303 may be configured to transmit an uplink signal with each of transmission beams in the scanning beam range, that is, to perform step S302 in FIG. 18B. The uplink signal includes uplink reference signal, such as SRS.

The receiving unit 302 may be further configured to receive, from the serving cell, indication information for an optimal transmission beam of the UE for uplink CoMP, that is, to perform step S303 in FIG. 18B. The optimal transmission beam may be determined based on signal quality of the uplink signal transmitted by the UE measured by the serving cell and at least one cooperating cell. For example, the indication information for the optimal transmission beam of the UE may be included in a TCI state.

The transmitting unit 303 may be further configured to perform uplink transmission with the optimal transmission beam, that is, to perform step S304 in FIG. 18B. Uplink data transmitted with this optimal transmission beam can be optimally received jointly by the serving cell and the cooperating cell.

The electronic device 300 may further include a communication unit 305. The communication unit 305 may be configured to communicate with the base station or satellite under the control of the processing circuitry 301. In one example, the communication unit 305 may be implemented as a transmitter or transceiver, including communication components such as antenna arrays and/or radio frequency links. The communication unit 305 is depicted with a dashed line, since it may also be located outside the electronic device 300.

The electronic device 300 may also include a memory 306. The memory 306 may store various data and instructions, such as programs and data for operation of the electronic device 300, various data generated by the processing circuitry 301, various control signaling or traffic data received or transmitted by the communication unit 305, and the like. The memory 306 is depicted with a dashed line, since it may also be located within the processing circuitry 301 or outside the electronic device 300.

Various aspects of the embodiments of the present disclosure have been described in detail above, but it will be appreciated that the structure, arrangement, type, number and the like of antenna arrays, ports, reference signals, communication devices, communication methods and the like are illustrated for purpose of description, and are not intended to limit the aspects of the present disclosure to these specific examples.

It should be understood that the various units of the electronic device 100, 200, and 300 described in the above embodiments are only logical modules divided according to specific functions they implement, and are not used to limit specific implementations. In an actual implementation, the foregoing units may be implemented as individual physical entities, or may also be implemented by a single entity (for example, a processor (CPU or DSP, etc.), an integrated circuit, etc.).

It should be understood that the processing circuitry 101, 201, or 301 described in the above embodiments may include, for example, circuits such as integrated circuit (IC), application specific integrated circuit (ASIC), a part or circuit of an individual processor core, an entire processor core, an individual processor, a programmable hardware device such as field programmable array (FPGA)), and/or a system including multiple processors. The memory 106, 206, or 306 may be a volatile and/or non-volatile memory. For example, the memory 106, 206, or 306 may include, but are not limited to, Random Access Memory (RAM), Dynamic Random Access Memory (DRAM), Static Random Access Memory (SRAM), Read Only Memory (ROM), flash memory.

It should be understood that the various units of the electronic device 100, 200, and 300 described in the above embodiments are only logical modules divided according to specific functions they implement, and are not used to limit specific implementations. In an actual implementation, the foregoing units may be implemented as individual physical entities, or may also be implemented by a single entity (for example, a processor (CPU or DSP, etc.), an integrated circuit, etc.).

### Exemplary Implementations of the Present Disclosure

According to the embodiments of the present disclosure, various implementations for practicing concepts of the present disclosure can be conceived, including but not limited to the following exemplary examples (EEs):

EE1. An electronic device for a base station in a non-terrestrial network, comprising:
processing circuitry configured to
determine to enable uplink coordinated multiple points transmission for a user equipment (UE) in a serving cell provided by the base station;
at least based on geographic location of the UE, coverage range and movement information of the serving cell, and coverage range and movement information of neighbor cells, select at least one cooperating cell from the neighbor cells, and determine a cooperation period for the uplink coordinated multiple points transmission; and
receive uplink transmission of the UE by cooperation of the serving cell and the at least one cooperating cell within the cooperation period.

EE2. The electronic device according to EE1, wherein the base station further provides the at least one cooperating cell.

EE3. The electronic device according to EE1, wherein the at least one cooperating cell is provided by a different base station than the base station, and wherein the processing circuitry is further configured to notify selection information of each cooperating cell and information on the cooperation period to respective base station.

EE4. The electronic device according to EE2 or 3, wherein selecting the at least one cooperating cell comprises:
acquiring measurement of signal quality of an uplink signal of the UE by each of the neighbor cells;
evaluating a potential coverage time of each of the neighbor cells over the UE; and
at least based on the measurement of signal quality and the potential coverage time of each of the neighbor cells, selecting the at least one cooperating cell.

EE5. The electronic device according to EE3, wherein selecting the at least one cooperating cell comprises:
instructing each of the neighbor cells to measure signal quality of an uplink signal of the UE and acquiring respective measurements;
evaluating a potential coverage time of each of the neighbor cells over the UE;
evaluating a connection time between the base station and a base station of each of the neighbor cells; and
at least based on the measurement of signal quality, the potential coverage time and the connection time of each of the neighbor cells, selecting the at least one cooperating cell.

EE6. The electronic device according to EE1, wherein the processing circuitry is further configured to:
determine a scanning beam range for the UE;
indicate the scanning beam range to the UE;
acquire measurements of signal quality of an uplink signal transmitted by the UE with each of transmission beams in the scanning beam range by the serving cell and the at least one cooperating cell;
based on the measurements of signal quality, determine a transmission beam of the UE for the uplink coordinated multiple points transmission.

EE7. The electronic device according to EE6, wherein indicating the scanning beam range to the UE comprises:
indicating a subset of a preconfigured set of transmission beams as the scanning beam range to the UE via downlink control information (DCI).

EE8. The electronic device according to EE2, wherein the serving cell and the at least one cooperating cell are provided by different satellites, and
wherein the processing circuitry is further configured to:
cause the serving cell and the at least one cooperating cell to measure a time advance (TA) for the UE;
based on measurements of the TA, calculate a reception delay for each cooperating cell relative to the serving cell; and
receive the uplink transmission of the UE by the at least one cooperating cell based on respective reception delay.

EE9. The electronic device according to EE3, wherein the serving cell and the at least one cooperating cell are provided by different satellites, and
wherein the processing circuitry is further configured to:
cause the serving cell to measure a time advance (TA) for the UE; and
send a measurement of the TA to respective base station corresponding to the at least one cooperating cell.

EE10. The electronic device according to EE1, wherein the processing circuitry is further configured to instruct the UE to report its current geographic location, beam direction and antenna radiation pattern, in response to determining to enable the uplink coordinated multiple points transmission for the UE.

EE11. The electronic device according to EE1, wherein the coverage range and movement information of the serving cell or the neighbor cell are based on geographic location, ephemeris, beam direction and antenna radiation pattern of the serving cell or the neighbor cell.

EE12. An electronic device for a base station in a non-terrestrial network (NTN), comprising:
processing circuitry configured to
receive, from another base station, selection information of a cooperating cell and information on a cooperation period for uplink coordinated multiple points transmission for a user equipment (UE); and
in response to the selection information, receive uplink transmission of the UE within the cooperating period by cooperation of the cooperating cell and a serving cell of the UE.

EE13. The electronic device according to EE12, wherein the processing circuitry is further configured to send geographic location, ephemeris, beam direction and antenna radiation pattern of its satellite to the another base station.

EE14. The electronic device according to EE12, wherein the processing circuitry is further configured to:
measure, by its cell, signal quality of an uplink signal of the UE; and
send measurement of the signal quality to the another base station, for the another base station to select the cooperating cell.

EE15. The electronic device according to EE12, wherein the processing circuitry is further configured to:
measure, by the cooperating cell, signal quality of an uplink signal transmitted by the UE with each of transmission beams in a scanning beam range; and
send measurements of the signal quality to the another base station, for the another base station to determine a transmission beam for the uplink coordinated multiple points transmission of the UE.

EE16. The electronic device according to EE12, wherein the processing circuitry is further configured to:
measure, by the cooperating cell, a time advance (TA) for the UE; and acquire, from the another base station, a TA for the UE measured by the serving cell;
calculate a reception delay for the cooperating cell relative to the serving cell based on measurements of the TA for the UE; and
receive, by the cooperating cell, the uplink transmission of the UE based on the determined reception delay.

EE17. An electronic device for a user equipment (UE), comprising:
processing circuitry configured to
receive, from a serving cell, information on a scanning beam range for the UE;
transmit an uplink signal with each of transmission beams in the scanning beam range;
receive, from the serving cell, indication information for an optimal transmission beam of the UE for uplink coordinated multiple points transmission, wherein the optimal transmission beam is determined based on signal quality of the uplink signal transmitted by the UE measured by the serving cell and at least one cooperating cell; and
perform uplink transmission with the optimal transmission beam.

EE18. A communication method, comprising:
determining to enable uplink coordinated multiple points transmission for a user equipment (UE) in a serving cell provided by a base station;
at least based on geographic location of the UE, coverage range and movement information of the serving cell, and coverage range and movement information of neighbor cells, selecting at least one cooperating cell from the neighbor cells, and determining a cooperation period for the uplink coordinated multiple points transmission; and
receiving uplink transmission of the UE by cooperation of the serving cell and the at least one cooperating cell within the cooperation period.

EE19. A communication method, comprising:
receiving, from another base station, selection information of a cooperating cell and information on a cooperation period for uplink coordinated multiple points transmission for a user equipment (UE); and
in response to the selection information, receiving uplink transmission of the UE within the cooperating period by cooperation of the cooperating cell and a serving cell of the UE.

EE20. A computer readable storage medium comprising executable instructions which, when executed, perform the communication method according to any of EE18-EE19.

### Application Examples of the Present Disclosure

The technology described in the present disclosure can be applied to various products.

For example, the electronic device 100 or 200 according to the embodiments of the present disclosure can be implemented as or installed in a variety of base stations, and the electronic device 300 can be implemented as or installed in a variety of UEs.

The communication method according to the embodiments of the present disclosure may be implemented by various base stations or user devices; the methods and operations according to the embodiments of the present disclosure may be embodied as computer-executable instructions, stored in a non-transitory computer-readable storage medium, and can be performed by various base stations or user devices to implement one or more of the above-mentioned functions.

The technology according to the embodiments of the present disclosure can be made into various computer program products, which can be used in various base stations or user devices to implement one or more of the above-mentioned functions.

The base stations mentioned in the present disclosure can be implemented as any type of base stations, preferably, such as the macro gNB or ng-eNB defined in the 3GPP 5G NR standard. A gNB may be a gNB that covers a cell smaller than a macro cell, such as a pico gNB, micro gNB, and home (femto) gNB. Instead, the base station may be implemented as any other types of base stations such as a NodeB, eNodeB and a base transceiver station (BTS). The base station may include a main body configured to control wireless communication, and one or more remote radio heads (RRH), a wireless relay station or the like disposed in a different place from the main body. The base station may be implemented at a high altitude platform such as a satellite, a drone, or the like.

The user equipment may be implemented as a mobile terminal such as a smartphone, a tablet personal computer (PC), a notebook PC, a portable game terminal, a portable/dongle type mobile router, and a digital camera apparatus, or an in-vehicle terminal such as a car navigation device. The user equipment may also be implemented as a terminal (that is also referred to as a machine type communication (MTC) terminal) that performs machine-to-machine (M2M) communication or the like. The user equipment may be implemented at a high altitude platform such as a satellite, a drone, or the like. Furthermore, the terminal device may be a wireless communication module (such as an integrated circuit module including a single die) mounted on each of the above terminals.

### First Application Example of the Base Station

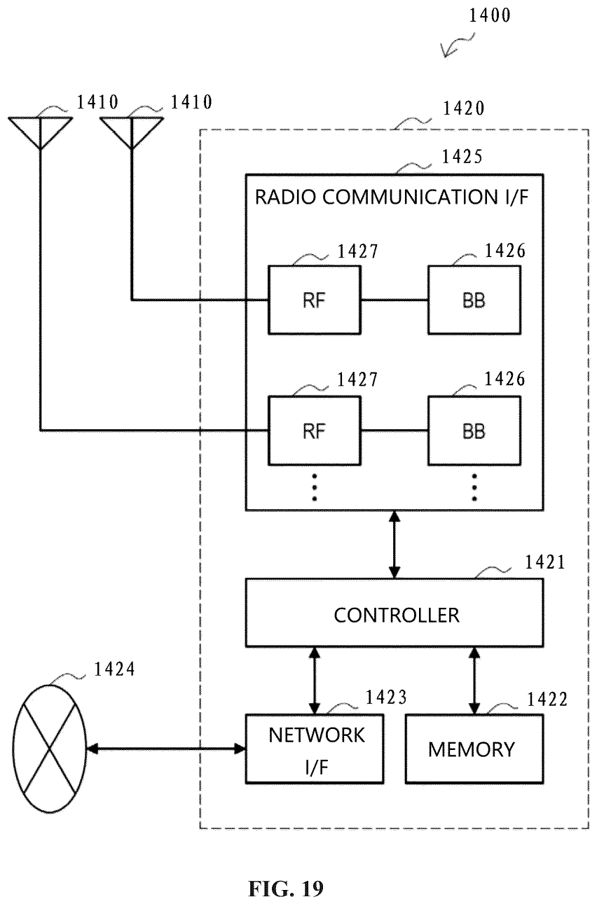

FIG. 19 is a block diagram showing a first example of a schematic configuration of a base station to which the technology of the present disclosure can be applied. In FIG. 19, the base station may be implemented as gNB 1400. The gNB 1400 includes a plurality of antennas 1410 and a base station device 1420. The base station device 1420 and each antenna 1410 may be connected to each other via an RF cable. In an implementation, the gNB 1400 (or the base station device 1420) herein may correspond to the above-mentioned electronic device 100 or 200.

The antennas 1410 includes multiple antenna elements. The antennas 1410, for example, can be arranged into a matrix of antenna arrays, and are used by the base station device 1420 to transmit and receive wireless signals. For example, multiple antennas 1410 may be compatible with multiple frequency bands used by gNB 1400.

The base station device 1420 includes a controller 1421, a memory 1422, a network interface 1423, and a radio communication interface 1425.

The controller 1421 may be, for example, a CPU or a DSP, and operates various functions of the base station device 1420 at a higher layer. For example, the controller 1421 may include the processing circuitry 101 or 201 as described above, perform the communication method described in FIG. 16B or 17B, or control various components of the electronic device 100 or 200. For example, the controller 1421 generates data packets based on data in signals processed by the radio communication interface 1425, and passes the generated packets via the network interface 1423. The controller 1421 may bundle data from multiple baseband processors to generate bundled packets, and pass the generated bundled packets. The controller 1421 may have logical functions that perform controls such as radio resource control, radio bearer control, mobility management, admission control, and scheduling. The controls can be performed in conjunction with a nearby gNB or core network node. The memory 1422 includes a RAM and a ROM, and stores a program executed by the controller 1421 and various types of control data such as a terminal list, transmission power data, and scheduling data.

The network interface 1423 is a communication interface for connecting the base station device 1420 to the core network 1424. The controller 1421 may communicate with a core network node or another gNB via the network interface 1423. In this case, the gNB 1400 and the core network node or other gNBs may be connected to each other through a logical interface such as an S1 interface and an X2 interface. The network interface 1423 may also be a wired communication interface or a radio communication interface for a wireless backhaul line. If the network interface 1423 is a radio communication interface, compared with the frequency band used by the radio communication interface 1425, the network interface 1423 can use a higher frequency band for wireless communication.

The radio communication interface 1425 supports any cellular communication scheme such as 5G NR, and provides a wireless connection to a terminal located in a cell of the gNB 1400 via an antenna 1410. The radio communication interface 1425 may generally include, for example, a baseband (BB) processor 1426 and an RF circuit 1427. The BB processor 1426 may perform, for example, encoding/decoding, modulation/demodulation, and multiplexing/demultiplexing, and execute various types of signal processing in layers such as the physical layer, the MAC layer, the RLC layer, and the PDCP layer. As an alternative of the controller 1421, the BB processor 1426 may have a part or all of the above-mentioned logical functions. The BB processor 1426 may be a memory storing a communication control program, or a module including a processor and related circuits configured to execute the program. Updating the program can change the function of the BB processor 1426. The module may be a card or a blade inserted into a slot of the base station device 1420. Alternatively, the module may be a chip mounted on a card or a blade. Meanwhile, the RF circuit 1427 may include, for example, a mixer, a filter, and an amplifier, and transmits and receives a wireless signal via the antenna 1410. Although FIG. 19 illustrates an example in which one RF circuit 1427 is connected to one antenna 1410, the present disclosure is not limited to this illustration, but one RF circuit 1427 may be connected to multiple antennas 1410 at the same time.

As shown in FIG. 19, the radio communication interface 1425 may include a plurality of BB processors 1426. For example, the plurality of BB processors 1426 may be compatible with multiple frequency bands used by gNB 1400. As shown in FIG. 19, the radio communication interface 1425 may include a plurality of RF circuits 1427. For example, the plurality of RF circuits 1427 may be compatible with multiple antenna elements. Although FIG. 19 shows an example in which the radio communication interface 1425 includes a plurality of BB processors 1426 and a plurality of RF circuits 1427, the radio communication interface 1425 may also include a single BB processor 1426 or a single RF circuit 1427.

In the gNB 1400 illustrated in FIG. 19, one or more of the units included in the processing circuitry 101 described with reference to FIG. 16A and the processing circuitry 201 described with reference to FIG. 17A may be implemented in the radio communication interface 1425. Alternatively, at least a part of these components may be implemented in the controller 1421. As an example, the gNB 1400 includes a part (for example, the BB processor 1426) or the entirety of the radio communication interface 1425 and/or a module including the controller 1421, and the one or more components may be implemented in the module. In this case, the module may store a program (in other words, a program causing the processor to execute operations of the one or more components) causing the processor to function as the one or more components, and execute the program. As another example, a program causing the processor to function as the one or more components may be installed in the gNB 1400, and the radio communication interface 1425 (for example, the BB processor 1426) and/or the controller 1421 may execute the program. As described above, as a device including the one or more components, the gNB 1400, the base station device 1420 or the module may be provided. In addition, a readable medium in which the program is recorded may be provided.

### Second Application Example of Base Station

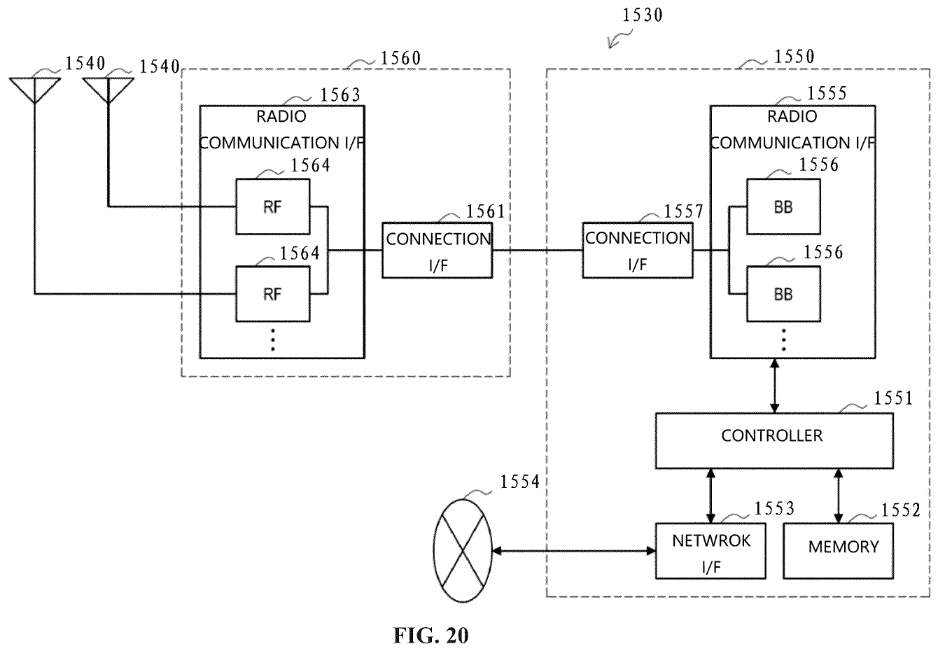

FIG. 20 is a block diagram showing a second example of a schematic configuration of a base station to which the technology of the present disclosure can be applied. In FIG. 20, the base station is shown as gNB 1530. The gNB 1530 includes multiple antennas 1540, base station equipment 1550, and RRH 1560. The RRH 1560 and each antenna 1540 may be connected to each other via an RF cable. The base station equipment 1550 and the RRH 1560 may be connected to each other via a high-speed line such as a fiber optic cable. In an implementation manner, the gNB 1530 (or the base station device 1550) herein may correspond to the foregoing electronic device 100 or 200.

The antennas 1540 includes multiple antenna elements. The antennas 1540, for example, can be arranged into a matrix of antenna arrays, and are used by the base station device 1550 to transmit and receive wireless signals. For example, multiple antennas 1540 may be compatible with multiple frequency bands used by gNB 1530.

The base station device 1550 includes a controller 1551, a memory 1552, a network interface 1553, a radio communication interface 1555, and a connection interface 1557. The controller 1551, the memory 1552, and the network interface 1553 are the same as the controller 1421, the memory 1422, and the network interface 1423 described with reference to FIG. 19.

The radio communication interface 1555 supports any cellular communication scheme such as 5G NR, and provides wireless communication to a terminal located in a sector corresponding to the RRH 1560 via the RRH 1560 and the antenna 1540. The radio communication interface 1555 may typically include, for example, a BB processor 1556. The BB processor 1556 is the same as the BB processor 1426 described with reference to FIG. 19 except that the BB processor 1556 is connected to the RF circuit 1564 of the RRH 1560 via the connection interface 1557. As shown in FIG. 20, the radio communication interface 1555 may include a plurality of BB processors 1556. For example, multiple BB processors 1556 may be compatible with multiple frequency bands used by gNB 1530. Although FIG. 20 shows an example in which the radio communication interface 1555 includes a plurality of BB processors 1556, the radio communication interface 1555 may also include a single BB processor 1556.

The connection interface 1557 is an interface for connecting the base station device 1550 (radio communication interface 1555) to the RRH 1560. The connection interface 1557 may also be a communication module for communication in the above-mentioned high-speed line connecting the base station device 1550 (radio communication interface 1555) to the RRH 1560.

The RRH 1560 includes a connection interface 1561 and a radio communication interface 1563.

The connection interface 1561 is an interface for connecting the RRH 1560 (radio communication interface 1563) to the base station device 1550. The connection interface 1561 may also be a communication module for communication in the above-mentioned high-speed line.

The radio communication interface 1563 transmits and receives wireless signals via the antenna 1540. The radio communication interface 1563 may generally include, for example, an RF circuit 1564. The RF circuit 1564 may include, for example, a mixer, a filter, and an amplifier, and transmits and receives wireless signals via the antenna 1540. Although FIG. 20 illustrates an example in which one RF circuit 1564 is connected to one antenna 1540, the present disclosure is not limited to this illustration, but one RF circuit 1564 may be connected to multiple antennas 1540 at the same time.

As shown in FIG. 20, the radio communication interface 1563 may include a plurality of RF circuits 1564. For example, the plurality of RF circuits 1564 may support multiple antenna elements. Although FIG. 20 shows an example in which the radio communication interface 1563 includes a plurality of RF circuits 1564, the radio communication interface 1563 may include a single RF circuit 1564.

In the gNB 1500 shown in FIG. 20, one or more of the units included in the processing circuitry 101 described with reference to FIG. 16A and the processing circuitry 201 described with reference to FIG. 17A may be implemented in the radio communication interface 1525. Alternatively, at least a part of these components may be implemented in the controller 1521. For example, the gNB 1500 includes a part (for example, the BB processor 1526) or the whole of the radio communication interface 1525, and/or a module including the controller 1521, and one or more components may be implemented in the module. In this case, the module may store a program for allowing the processor to function as one or more components (in other words, a program for allowing the processor to perform operations of one or more components), and may execute the program. As another example, a program for allowing the processor to function as one or more components may be installed in the gNB 1500, and the radio communication interface 1525 (for example, the BB processor 1526) and/or the controller 1521 may execute the program. As described above, as a device including one or more components, the gNB 1500, the base station device 1520, or a module may be provided, and a program for allowing the processor to function as one or more components may be provided. In addition, a readable medium in which the program is recorded may be provided.

### First Application Example of the User Equipment

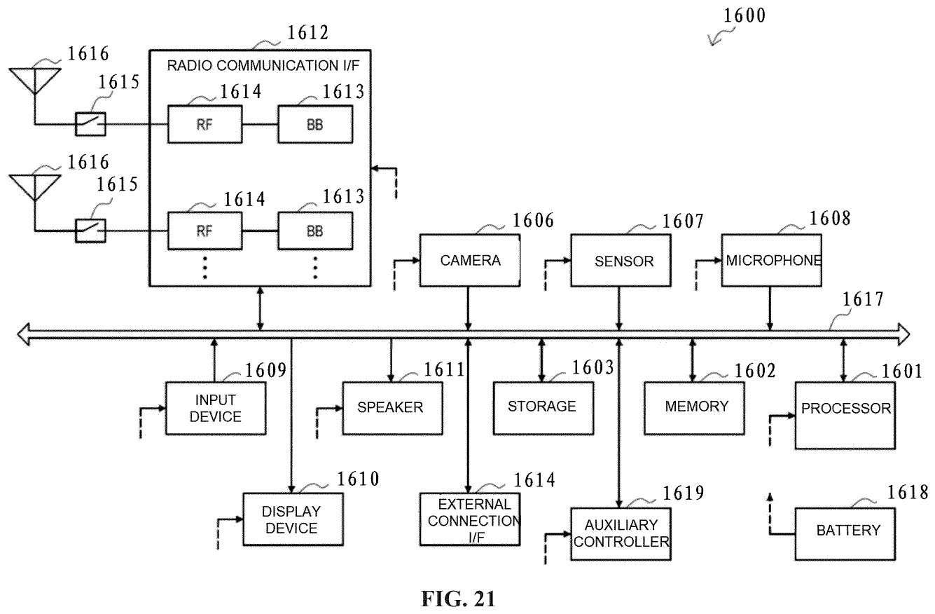

FIG. 21 is a block diagram showing an example of a schematic configuration of a smartphone 1600 to which the technology of the present disclosure can be applied. In an example, the smart phone 1600 may be implemented as the electronic device 300 described in the present disclosure.

The smartphone 1600 includes a processor 1601, a memory 1602, a storage device 1603, an external connection interface 1604, a camera device 1606, a sensor 1607, a microphone 1608, an input device 1609, a display device 1610, a speaker 1611, a radio communication interface 1612, one or more antenna switches 1615, one or more antennas 1616, a bus 1617, a battery 1618, and an auxiliary controller 1619.

The processor 1601 may be, for example, a CPU or a system on chip (SoC), and controls functions of an application layer and another layer of the smartphone 1600. The processor 1601 may include or serve as the processing circuitry 301 described with reference to FIG. 18A. The memory 1602 includes a RAM and a ROM, and stores data and programs executed by the processor 1601. The storage device 1603 may include a storage medium such as a semiconductor memory and a hard disk. The external connection interface 1604 is an interface for connecting external devices such as a memory card and a universal serial bus (USB) device to the smartphone 1600.

The camera device 1606 includes an image sensor such as a charge-coupled device (CCD) and a complementary metal oxide semiconductor (CMOS), and generates a captured image. The sensor 1607 may include a set of sensors such as a measurement sensor, a gyroscope sensor, a geomagnetic sensor, and an acceleration sensor. The microphone 1608 converts a sound input to the smartphone 1600 into an audio signal. The input device 1609 includes, for example, a touch sensor, a keypad, a keyboard, a button, or a switch configured to detect a touch on the screen of the display device 1610, and receives an operation or information input from a user. The display device 1610 includes a screen such as a liquid crystal display (LCD) and an organic light emitting diode (OLED) display, and displays an output image of the smartphone 1600. The speaker 1611 converts an audio signal output from the smartphone 1600 into a sound.

The radio communication interface 1612 supports any cellular communication scheme such as 4G LTE, 5G NR or the like, and performs wireless communication. The radio communication interface 1612 may generally include, for example, a BB processor 1613 and an RF circuit 1614. The BB processor 1613 may perform, for example, encoding/decoding, modulation/demodulation, and multiplexing/demultiplexing, and perform various types of signal processing for wireless communication. Meanwhile, the RF circuit 1614 may include, for example, a mixer, a filter, and an amplifier, and transmits and receives wireless signals via the antenna 1616. The radio communication interface 1612 may be a chip module on which a BB processor 1613 and an RF circuit 1614 are integrated. As shown in FIG. 21, the radio communication interface 1612 may include multiple BB processors 1613 and multiple RF circuits 1614. Although FIG. 21 illustrates an example in which the radio communication interface 1612 includes a plurality of BB processors 1613 and a plurality of RF circuits 1614, the radio communication interface 1612 may also include a single BB processor 1613 or a single RF circuit 1614.

In addition, in addition to the cellular communication scheme, the radio communication interface 1612 may support other types of wireless communication scheme, such as a short-range wireless communication scheme, a near field communication scheme, and a wireless local area network (LAN) scheme. In this case, the radio communication interface 1612 may include a BB processor 1613 and an RF circuit 1614 for each wireless communication scheme.

Each of the antenna switches 1615 switches a connection destination of the antenna 1616 between a plurality of circuits included in the radio communication interface 1612 (for example, circuits for different wireless communication schemes).

The antennas 1616 includes multiple antenna elements. The antennas 1616, for example, can be arranged into a matrix of antenna arrays, and are used by the radio communication interface 1612 to transmit and receive wireless signals. The smart phone 1600 can includes one or more antenna panels (not shown).

In addition, the smartphone 1600 may include an antenna 1616 for each wireless communication scheme. In this case, the antenna switch 1615 may be omitted from the configuration of the smartphone 1600.

The bus 1617 connects the processor 1601, the memory 1602, the storage device 1603, the external connection interface 1604, the camera device 1606, the sensor 1607, the microphone 1608, the input device 1609, the display device 1610, the speaker 1611, the radio communication interface 1612, and the auxiliary controller 1619 to each other. The battery 1618 supplies power to each block of the smartphone 1600 shown in FIG. 21 via a feeder, and the feeder is partially shown as a dotted line in the figure. The auxiliary controller 1619 operates the minimum necessary functions of the smartphone 1600 in the sleep mode, for example.

In the smart phone 1600 shown in FIG. 21, one or more of the components included in the processing circuitry may be implemented in the radio communication interface 1612, such the receiving unit 302 or the transmitting 303 of the processing circuitry 301 described with reference to FIG. 18A. Alternatively, at least a part of these components may be implemented in the processor 1601 or the auxiliary controller 1619. As an example, the smart phone 1600 includes a part (for example, the BB processor 1613) or the whole of the radio communication interface 1612, and/or a module including the processor 1601 and/or the auxiliary controller 1619, and one or more components may be Implemented in this module. In this case, the module may store a program that allows processing to function as one or more components (in other words, a program for allowing the processor to perform operations of one or more components), and may execute the program. As another example, a program for allowing the processor to function as one or more components may be installed in the smart phone 1600, and the radio communication interface 1612 (for example, the BB processor 1613), the processor 1601, and/or the auxiliary The controller 1619 can execute this program. As described above, as a device including one or more components, a smart phone 1600 or a module may be provided, and a program for allowing a processor to function as one or more components may be provided. In addition, a readable medium in which the program is recorded may be provided.

### Second Application Example of the User Equipment

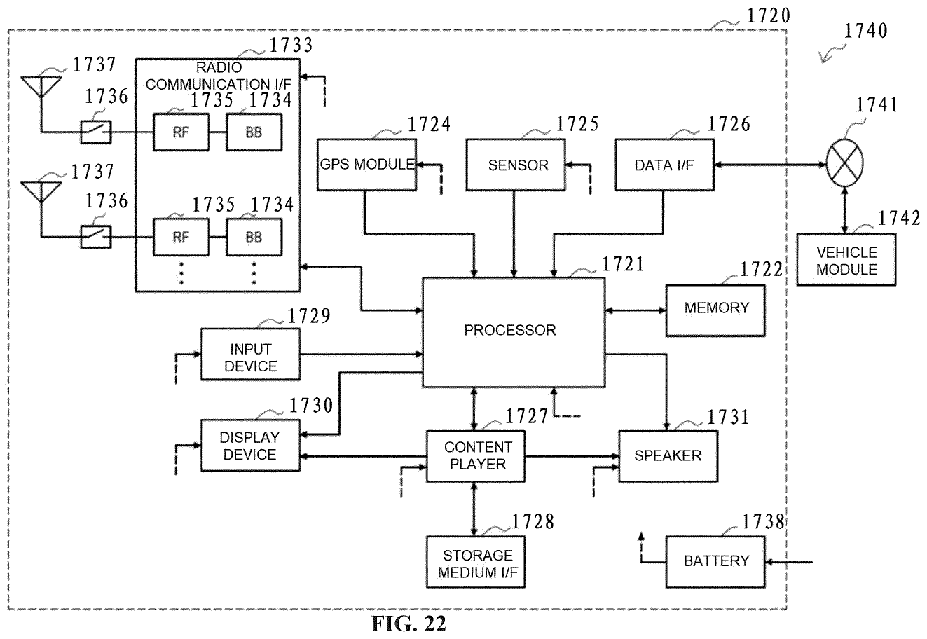

FIG. 22 is a block diagram showing an example of a schematic configuration of a car navigation device 1720 to which the technology of the present disclosure can be applied. The car navigation device 1720 may be implemented as the electronic device 300 described with reference to FIG. 18A. The car navigation device 1720 includes a processor 1721, a memory 1722, a global positioning system (GPS) module 1724, a sensor 1725, a data interface 1726, a content player 1727, a storage medium interface 1728, an input device 1729, a display device 1730, a speaker 1731, and a radio communication interface 1733, one or more antenna switches 1736, one or more antennas 1737, and a battery 1738. In an example, the car navigation device may be implemented as the UE described in the present disclosure.

The processor 1721 may be, for example, a CPU or a SoC, and controls navigation functions and other functions of the car navigation device 1720. The memory 1722 includes a RAM and a ROM, and stores data and programs executed by the processor 1721.

The GPS module 1724 uses a GPS signal received from a GPS satellite to measure the position (such as latitude, longitude, and altitude) of the car navigation device 1720. The sensor 1725 may include a set of sensors such as a gyroscope sensor, a geomagnetic sensor, and an air pressure sensor. The data interface 1726 is connected to, for example, an in-vehicle network 1741 via a terminal not shown, and acquires data (such as vehicle speed data) generated by the vehicle.

The content player 1727 reproduces content stored in a storage medium such as a CD and a DVD, which is inserted into the storage medium interface 1728. The input device 1729 includes, for example, a touch sensor, a button, or a switch configured to detect a touch on the screen of the display device 1730, and receives an operation or information input from a user. The display device 1730 includes a screen such as an LCD or OLED display, and displays an image of a navigation function or reproduced content. The speaker 1731 outputs the sound of the navigation function or the reproduced content.

The radio communication interface 1733 supports any cellular communication scheme such as the 4G LTE or the 5G NR, and performs wireless communication. The radio communication interface 1733 may generally include, for example, a BB processor 1734 and an RF circuit 1735. The BB processor 1734 may perform, for example, encoding/decoding, modulation/demodulation, and multiplexing/demultiplexing, and perform various types of signal processing for wireless communication. Meanwhile, the RF circuit 1735 may include, for example, a mixer, a filter, and an amplifier, and transmit and receive wireless signals via the antenna 1737. The radio communication interface 1733 may also be a chip module on which a BB processor 1734 and an RF circuit 1735 are integrated. As shown in FIG. 22, the radio communication interface 1733 may include a plurality of BB processors 1734 and a plurality of RF circuits 1735. Although FIG. 22 shows an example in which the radio communication interface 1733 includes a plurality of BB processors 1734 and a plurality of RF circuits 1735, the radio communication interface 1733 may also include a single BB processor 1734 or a single RF circuit 1735.

In addition, in addition to the cellular communication scheme, the radio communication interface 1733 may support other types of wireless communication scheme, such as a short-range wireless communication scheme, a near field communication scheme, and a wireless LAN scheme. In this case, the radio communication interface 1733 may include a BB processor 1734 and an RF circuit 1735 for each wireless communication scheme.

Each of the antenna switches 1736 switches the connection destination of the antenna 1737 between a plurality of circuits included in the radio communication interface 1733, such as circuits for different wireless communication schemes.

The antennas 1737 includes multiple antenna elements. The antennas 1737, for example, can be arranged into a matrix of antenna arrays, and are used by the radio communication interface 1733 to transmit and receive wireless signals.

In addition, the car navigation device 1720 may include an antenna 1737 for each wireless communication scheme. In this case, the antenna switch 1736 may be omitted from the configuration of the car navigation device 1720.

The battery 1738 supplies power to each block of the car navigation device 1720 shown in FIG. 22 via a feeder, and the feeder is partially shown as a dotted line in the figure. The battery 1738 accumulates power provided from the vehicle.

In the car navigation device 1720 shown in FIG. 22, one or more of the components included in the processing circuitry can be implemented in the radio communication interface 1733, such as the receiving unit 302 or the transmitting unit 303 of the processing circuitry 301 described with reference to FIG. 18A. Alternatively, at least a part of these components may be implemented in the processor 1721. As an example, the car navigation device 1720 includes a part (for example, the BB processor 1734) or the whole of the radio communication interface 1733, and/or a module including the processor 1721, and one or more components may be implemented in the module. In this case, the module may store a program that allows processing to function as one or more components (in other words, a program for allowing the processor to perform operations of one or more components), and may execute the program. As another example, a program for allowing the processor to function as one or more components may be installed in the car navigation device 1720, and the radio communication interface 1733 (for example, the BB processor 1734) and/or the processor 1721 may Execute the procedure. As described above, as a device including one or more components, a car navigation device 1720 or a module may be provided, and a program for allowing the processor to function as one or more components may be provided. In addition, a readable medium in which the program is recorded may be provided.

The technology of the present disclosure may also be implemented as an in-vehicle system (or vehicle) 1740 including one or more of a car navigation device 1720, an in-vehicle network 1741, and a vehicle module 1742. The vehicle module 1742 generates vehicle data such as vehicle speed, engine speed, and failure information, and outputs the generated data to the in-vehicle network 1741.

Although the illustrative embodiments of the present disclosure have been described with reference to the accompanying drawings, the present disclosure is certainly not limited to the above examples. Those skilled in the art may achieve various adaptions and modifications within the scope of the appended claims, and it will be appreciated that these adaptions and modifications certainly fall into the scope of the technology of the present disclosure.

For example, in the above embodiments, the multiple functions included in one module may be implemented by separate means. Alternatively, in the above embodiments, the multiple functions included in multiple modules may be implemented by separate means, respectively. In additions, one of the above functions may be implemented by multiple modules. Needless to say, such configurations are included in the scope of the technology of the present disclosure.

In this specification, the steps described in the flowcharts include not only the processes performed sequentially in chronological order, but also the processes performed in parallel or separately but not necessarily performed in chronological order. Furthermore, even in the steps performed in chronological order, needless to say, the order may be changed appropriately.

Although the present disclosure and its advantages have been described in detail, it will be appreciated that various changes, replacements and transformations may be made without departing from the spirit and scope of the present disclosure as defined by the appended claims. In addition, the terms “include”, “comprise” or any other variants of the embodiments of the present disclosure are intended to be non-exclusive inclusion, such that the process, method, article or device including a series of elements includes not only these elements, but also those that are not listed specifically, or those that are inherent to the process, method, article or device. In case of further limitations, the element defined by the sentence “include one” does not exclude the presence of additional same elements in the process, method, article or device including this element.

1. An electronic device for a base station in a non-terrestrial network, comprising:
processing circuitry configured to
determine to enable uplink coordinated multiple points transmission for a user equipment (UE) in a serving cell provided by the base station;
at least based on geographic location of the UE, coverage range and movement information of the serving cell, and coverage range and movement information of neighbor cells, select at least one cooperating cell from the neighbor cells, and determine a cooperation period for the uplink coordinated multiple points transmission; and
receive uplink transmission of the UE by cooperation of the serving cell and the at least one cooperating cell within the cooperation period.

2. The electronic device according to claim 1, wherein the base station further provides the at least one cooperating cell.

3. The electronic device according to claim 1, wherein the at least one cooperating cell is provided by a different base station than the base station, and
wherein the processing circuitry is further configured to notify selection information of each cooperating cell and information on the cooperation period to respective base station.

4. The electronic device according to claim 2, wherein selecting the at least one cooperating cell comprises:
acquiring measurement of signal quality of an uplink signal of the UE by each of the neighbor cells;
evaluating a potential coverage time of each of the neighbor cells over the UE; and
at least based on the measurement of signal quality and the potential coverage time of each of the neighbor cells, selecting the at least one cooperating cell.

5. The electronic device according to claim 3, wherein selecting the at least one cooperating cell comprises:
instructing each of the neighbor cells to measure signal quality of an uplink signal of the UE and acquiring respective measurements;
evaluating a potential coverage time of each of the neighbor cells over the UE;
evaluating a connection time between the base station and a base station of each of the neighbor cells; and
at least based on the measurement of signal quality, the potential coverage time and the connection time of each of the neighbor cells, selecting the at least one cooperating cell.

6. The electronic device according to claim 1, wherein the processing circuitry is further configured to:
determine a scanning beam range for the UE;
indicate the scanning beam range to the UE;
acquire measurements of signal quality of an uplink signal transmitted by the UE with each of transmission beams in the scanning beam range by the serving cell and the at least one cooperating cell;
based on the measurements of signal quality, determine a transmission beam of the UE for the uplink coordinated multiple points transmission.

7. The electronic device according to claim 6, wherein indicating the scanning beam range to the UE comprises:
indicating a subset of a preconfigured set of transmission beams as the scanning beam range to the UE via downlink control information (DCI).

8. The electronic device according to claim 2, wherein the serving cell and the at least one cooperating cell are provided by different satellites, and
wherein the processing circuitry is further configured to:
cause the serving cell and the at least one cooperating cell to measure a time advance (TA) for the UE;
based on measurements of the TA, calculate a reception delay for each cooperating cell relative to the serving cell; and
receive the uplink transmission of the UE by the at least one cooperating cell based on respective reception delay.

9. The electronic device according to claim 3, wherein the serving cell and the at least one cooperating cell are provided by different satellites, and
wherein the processing circuitry is further configured to:
cause the serving cell to measure a time advance (TA) for the UE; and
send a measurement of the TA to respective base station corresponding to the at least one cooperating cell.

10. The electronic device according to claim 1, wherein the processing circuitry is further configured to instruct the UE to report its current geographic location, beam direction and antenna radiation pattern, in response to determining to enable the uplink coordinated multiple points transmission for the UE.

11. The electronic device according to claim 1, wherein the coverage range and movement information of the serving cell or the neighbor cell are based on geographic location, ephemeris, beam direction and antenna radiation pattern of the serving cell or the neighbor cell.

12. An electronic device for a base station in a non-terrestrial network (NTN), comprising:
processing circuitry configured to
receive, from another base station, selection information of a cooperating cell and information on a cooperation period for uplink coordinated multiple points transmission for a user equipment (UE); and
in response to the selection information, receive uplink transmission of the UE within the cooperating period by cooperation of the cooperating cell and a serving cell of the UE.

13. The electronic device according to claim 12, wherein the processing circuitry is further configured to send geographic location, ephemeris, beam direction and antenna radiation pattern of its satellite to the another base station.

14. The electronic device according to claim 12, wherein the processing circuitry is further configured to:
measure, by its cell, signal quality of an uplink signal of the UE; and
send measurement of the signal quality to the another base station, for the another base station to select the cooperating cell.

15. The electronic device according to claim 12, wherein the processing circuitry is further configured to:
measure, by the cooperating cell, signal quality of an uplink signal transmitted by the UE with each of transmission beams in a scanning beam range; and
send measurements of the signal quality to the another base station, for the another base station to determine a transmission beam for the uplink coordinated multiple points transmission of the UE.

16. The electronic device according to claim 12, wherein the processing circuitry is further configured to:
measure, by the cooperating cell, a time advance (TA) for the UE; and
acquire, from the another base station, a TA for the UE measured by the serving cell;
calculate a reception delay for the cooperating cell relative to the serving cell based on measurements of the TA for the UE; and
receive, by the cooperating cell, the uplink transmission of the UE based on the determined reception delay.

17. An electronic device for a user equipment (UE), comprising:
processing circuitry configured to
receive, from a serving cell, information on a scanning beam range for the UE;
transmit an uplink signal with each of transmission beams in the scanning beam range;
receive, from the serving cell, indication information for an optimal transmission beam of the UE for uplink coordinated multiple points transmission, wherein the optimal transmission beam is determined based on signal quality of the uplink signal transmitted by the UE measured by the serving cell and at least one cooperating cell; and
perform uplink transmission with the optimal transmission beam.

18. A communication method, comprising:
determining to enable uplink coordinated multiple points transmission for a user equipment (UE) in a serving cell provided by a base station;
at least based on geographic location of the UE, coverage range and movement information of the serving cell, and coverage range and movement information of neighbor cells, selecting at least one cooperating cell from the neighbor cells, and determining a cooperation period for the uplink coordinated multiple points transmission; and
receiving uplink transmission of the UE by cooperation of the serving cell and the at least one cooperating cell within the cooperation period.

19. A communication method, comprising:
receiving, from another base station, selection information of a cooperating cell and information on a cooperation period for uplink coordinated multiple points transmission for a user equipment (UE); and
in response to the selection information, receiving uplink transmission of the UE within the cooperating period by cooperation of the cooperating cell and a serving cell of the UE.

20. A computer readable storage medium comprising executable instructions which, when executed, perform the communication method according to claim 18.
